(19) United States
(12) Patent Application Publication
(10) Pub. No.: US 2025/0193505 A1
(43) Pub. Date: Jun. 12, 2025

(54) OVEN WITH ADJUSTABLE BRIGHTNESS AND OVEN OPERATION METHOD THEREOF

(71) Applicant: SAMSUNG ELECTRONICS CO., LTD., Suwon-si (KR)

(72) Inventors: Jihyung HA, Suwon-si (KR); Yunwon MOON, Suwon-si (KR); Sangyong LEE, Suwon-si (KR); Mukyong KIM, Suwon-si (KR); Jueon KIM, Suwon-si (KR); Kyungah CHANG, Suwon-si (KR)

(73) Assignee: SAMSUNG ELECTRONICS CO., LTD., Suwon-si (KR)

(21) Appl. No.: 19/054,377

(22) Filed: Feb. 14, 2025

Related U.S. Application Data
(63) Continuation of application No. PCT/KR2023/010733, filed on Jul. 25, 2023.

(30) Foreign Application Priority Data
Sep. 22, 2022 (KR) 10-2022-0120167
Apr. 10, 2023 (KR) 10-2023-0046937

(51) Int. Cl. H04N 23/50; A47J 36/32; F24C 15/00; H04N 7/18; H04N 23/71; H04N 23/72; H04N 23/73; H04N 23/74

(52) U.S. Cl. CPC H04N 23/555; A47J 36/321; F24C 15/008; H04N 7/183; H04N 23/71; H04N 23/72; H04N 23/73; H04N 23/74

(57) ABSTRACT

An oven includes a cooking chamber, a camera configured to obtain an image of an inside of the cooking chamber, at least one lamp disposed adjacent to the camera, one or more processors comprising processing circuitry, and a memory storing one or more instructions. The one or more instructions, when executed by the one or more processors individually or collectively, cause the oven to obtain, from the camera, an exposure value according to an automatic exposure (AE) operation of the camera, compare the obtained exposure value with a preset reference exposure value, and adjust a brightness level of the at least one lamp so that the obtained exposure value corresponds to the preset reference exposure value, based on a result of comparing the obtained exposure value with the preset reference exposure value.

### CROSS-REFERENCE TO RELATED APPLICATIONS

This application is a continuation application of International Application No. PCT/KR2023/010733, filed on Jul. 25, 2023, which claims priority to Korean Patent Application No. 10-2022-0120167, filed on Sep. 22, 2022, and Korean Patent Application No. 10-2023-0046937, filed on Apr. 10, 2023, in the Korean Intellectual Property Office, the disclosures of which are incorporated by reference herein in their entireties.

### BACKGROUND

### 1. Field

The present disclosure relates generally to ovens, and more particularly, to an oven capable of controlling brightness of a cooking room and a method of operating the oven.

### 2. Description of Related Art

An oven may refer to a tool and/or a device that may cook food using convection heat transfer. For example, the oven may include a cooking chamber (or cooking room), a heating device (or a heater), and a convection fan (or circulating fan). The oven may use the heating device to warm and/or heat the air inside the cooking chamber, and may use the convection fan to evenly distribute the heat inside the cooking chamber, in order to cook the food at least relatively uniformly, including inside (or interior) portions of the food.

Recently, other components, such as, but not limited to, a camera, may have been added to the oven to monitor the condition of the food. For example, a cooking process of food may be checked (or monitored) by capturing an image using a camera function.

However, a brightness level of the oven (e.g., inside the cooking chamber) may be fixed, and as a result, the brightness of the captured image may not be clear. Consequently, users and/or artificial intelligence (AI) may not be able to accurately recognize the state of the inside of the cooking chamber and/or an object (e.g., a food item) in the cooking chamber.

That is, an electronic device equipped with a camera for obtaining an image of an internal space, such as an oven, may be unable to accurately recognize the state of the internal space or an object in the internal space when the brightness of the obtained image is not clear.

### SUMMARY

One or more example embodiments of the present disclosure provide an oven capable of actively controlling brightness inside a cooking chamber based on an exposure value of a camera and a method of operating the oven may be provided

According to an aspect of the present disclosure, an oven includes a cooking chamber, a camera configured to obtain an image of an inside of the cooking chamber, at least one lamp disposed adjacent to the camera, one or more processors comprising processing circuitry, and a memory storing one or more instructions. The one or more instructions, when executed by the one or more processors individually or collectively, cause the oven to obtain, from the camera, an exposure value according to an automatic exposure (AE) operation of the camera, compare the obtained exposure value with a preset reference exposure value, and adjust a brightness level of the at least one lamp so that the obtained exposure value corresponds to the preset reference exposure value, based on a result of comparing the obtained exposure value with the preset reference exposure value.

According to an aspect of the present disclosure, a method of operating an oven includes obtaining, from a camera of the oven, an exposure value according to an AE operation of the camera, comparing the obtained exposure value with a preset reference exposure value, and adjusting a brightness level of at least one lamp of the oven so that the obtained exposure value corresponds to the preset reference exposure value based on the comparing of the obtained exposure value with the preset reference exposure value.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 is a diagram of a network based on an oven, according to an embodiment of the present disclosure;

FIG. 2 is a diagram illustrating a relationship between ambient brightness of a camera and an appropriate exposure value when an automatic exposure (AE) operation of the camera is in a stable state, according to an embodiment of the present disclosure;

FIG. 3 is a functional block diagram of an oven, according to an embodiment of the present disclosure;

FIG. 4 is a diagram of a pulse width modulation (PWM) signal transmitted from a processor to a lamp to control a brightness level of the lamp, according to an embodiment of the present disclosure;

FIG. 5 is a diagram of a direct current (DC) voltage value transmitted from a processor to a lamp to control a brightness level of the lamp, according to an embodiment of the present disclosure;

FIG. 6 illustrates an example of a table in which pulse width information of a PWM signal for controlling brightness of a lamp and an exposure value of a camera are mapped, according to an embodiment of the present disclosure;

FIG. 7 is a flowchart of a method of operating an oven, according to an embodiment of the present disclosure;

FIG. 8 is a flowchart of a method of operating an oven, according to an embodiment of the present disclosure;

FIG. 9 is a flowchart of a method of operating an oven, according to an embodiment of the present disclosure;

FIG. 10 is a flowchart of a method of operating an oven, according to an embodiment of the present disclosure;

FIG. 11 is a flowchart of a method of operating an oven, according to an embodiment of the present disclosure;

FIG. 12 is a diagram illustrating components of an oven, according to an embodiment of the present disclosure;

FIG. 13 is a block diagram of a configuration of an oven, according to an embodiment of the present disclosure;

FIG. 14 is a flowchart of a method of operating an oven, according to an embodiment of the present disclosure;

FIG. 15 is a flowchart of a method of operating an oven, according to an embodiment of the present disclosure;

FIG. 16 is a flowchart of a method of operating an oven, according to an embodiment of the present disclosure;

FIG. 17 is a network configuration diagram based on an electronic device, according to an embodiment of the present disclosure;

FIG. 18 is a flowchart illustrating an operation of an electronic device, according to an embodiment of the present disclosure; and

FIG. 19 is a flowchart illustrating an operation of an electronic device, according to an embodiment of the present disclosure.

### DETAILED DESCRIPTION

The terms used in the present disclosure are described, and embodiments of the present disclosure are described.

The terms used in the present disclosure are general terms that are to be interpreted based on widely used interpretations in consideration of the functions in the present disclosure, however, such interpretations may be changed according to an intention of a technician in the art, a precedent, the advent of new technologies, or the like. Also, particular cases may include terms arbitrarily selected by an applicant, and in this case, the meaning of the terms may be described in the corresponding description. Therefore, the terms used in the present disclosure are to be defined based on the meanings of the terms and the content throughout the present disclosure, rather than simply based on the titles of the terms.

Throughout the present disclosure, the expression “at least one of a, b or c” may indicate “a,” “b,” “c,” “a and b,” “a and c,” “b and c,” “all of a, b, and c,” or variations thereof.

In the present disclosure, the expression “and/or” includes a combination of a plurality of described components or any component of the plurality of described components. In the present disclosure, terms such as “1st,” “2nd,” “first,” and “second” may be merely used to distinguish a corresponding component from other corresponding components and may not limit the corresponding components in terms of other aspects (e.g., the degree of importance or the order).

Throughout the present disclosure, when a part “includes” or “comprises” an element, the part may further include other elements, not excluding the other elements, unless there is a particular description contrary thereto.

In addition, the terms “portion,” “module,” or the like described in the present disclosure may denote a unit configured to process at least one function or operation, and the “portion,” the “module”, or the like may be realized as hardware or software, such as, but not limited to, a field programmable gate array (FPGA), an application specific integrated circuit (ASIC), or a combination of the hardware and the software. The term “portion” as used in an embodiment of the present disclosure may not have a meaning limited to software or hardware. A “portion” described in the present disclosure may be configured to be in a storage medium which may be addressed and/or may be configured to execute in one or more processors. According to an embodiment of the present disclosure, a “portion” may include components, such as, but not limited to, software components, object-oriented software components, class components, task components, processes, functions, attributes, procedures, sub-routines, segments of a program code, drivers, firmware, a microcode, a circuit, data, a database, data structures, tables, arrays, variables, or the like. Functions provided through a predetermined component or a predetermined “portion” may be combined to reduce the number of functions or may be divided into additional components. According to an embodiment, a “portion” may include one or more processors.

According to an embodiment of the present disclosure, each of blocks of the flowcharts and combinations of the flowcharts may be performed by computer program instructions. The computer program instructions may be loaded on a general-purpose computer, a specialized computer, or a processor of other programmable data processing device. The instructions performed through the computer or the processor of the other programmable data processing device may generate a medium for performing the functions described in the flowchart blocks. The computer program instructions may also be stored in a computer-available and/or computer-readable memory oriented for the computer or the other programmable data processing device in order to realize the functions in a specific way. The instructions stored in the computer-available or computer-readable memory may also produce manufacturing items embedding an instruction medium for performing the functions described in the flowchart blocks. The computer program instructions may also be loaded on the computer or the other programmable data processing device.

Each block in the flowcharts may represent a module, segment, or a part of code including one or more executable instructions to perform particular logic functions. According to an embodiment of the present disclosure, the functions described with respect to the blocks may also be generated not according to an order. For example, two blocks shown in succession may be executed substantially concurrently, or the blocks may sometimes be executed in a reverse order, depending on the functions involved therein.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, embodiments of the present disclosure are described with reference to the accompanying drawings, so that the embodiments of the present disclosure may be implemented by one of ordinary skill in the art. However, an embodiment of the present disclosure may have different forms and should not be construed as being limited to the embodiment of the present disclosure described herein. In addition, in the drawings, parts not related to descriptions may be omitted for clarity, and throughout the specification, like reference numerals may be used for like elements.

According to an embodiment of the present disclosure, an oven capable of actively controlling brightness inside a cooking chamber based on an exposure value of a camera and a method of operating the oven may be provided. Accordingly, a clearer image of the inside of the cooking chamber (or a cooking chamber image) may be provided, and thus, a user or artificial intelligence (AI) may easily and/or accurately check the state of the inside of the cooking chamber, the state of food (or object) being cooked, and/or the food (or object) being cooked.

According to an embodiment of the present disclosure, an electronic device capable of actively controlling brightness of an internal space of a main body based on an exposure value of a camera and a method of operating the electronic device may be provided. Accordingly, a clearer image of the internal space of the main body may be provided, and thus, a user or AI may easily and/or accurately check the state of the internal space of the main body or the state (or object) of an object in the internal space of the main body.

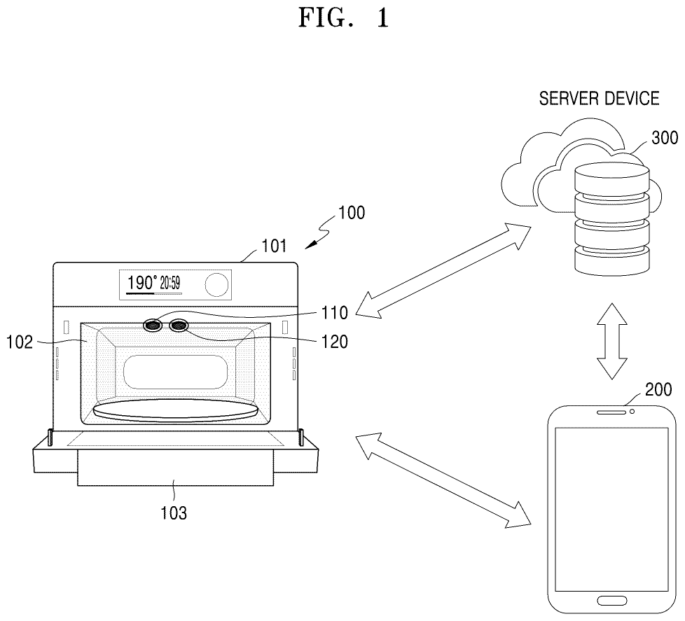

FIG. 1 is a diagram of a network based on an oven 100, according to an embodiment of the present disclosure.

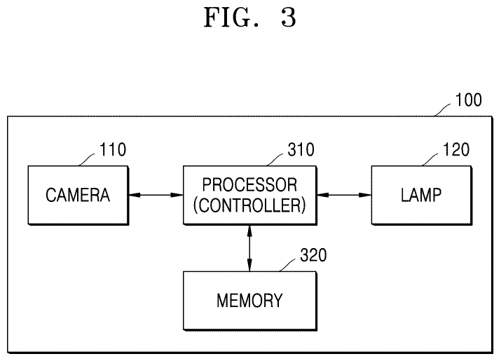

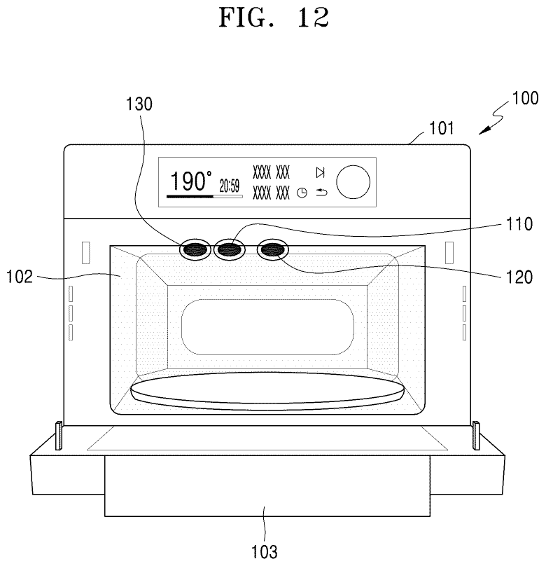

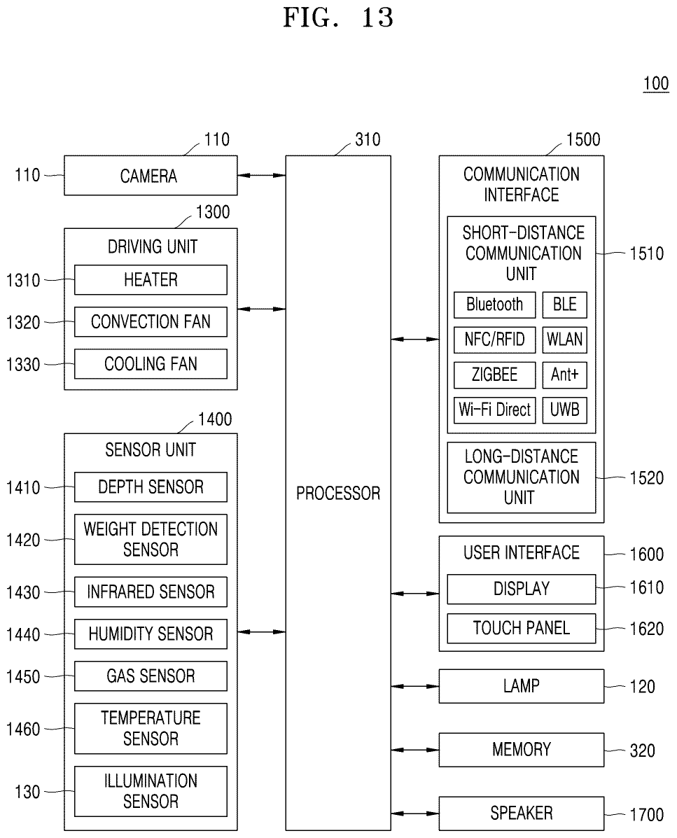

Referring to FIG. 1, the oven 100, according to an embodiment of the present disclosure, may include a main body 101, a cooking chamber 102, a door 103, a camera 110, and a lamp 120, however, the configuration of the oven 100 is not limited thereto. For example, the oven 100 may further include at least one processor 310 and a memory 320 shown in FIG. 3 to be described below. For example, the oven 100 may further include an illuminance sensor 130 shown in FIG. 12. For example, the oven 100 may include a plurality of lamps 120 according to the size of the oven 100. For example, the oven 100 may include a plurality of cameras 110 according to the size of the oven 100. For example, the oven 100 may further include a driving unit 1300, a sensor unit 1400, a communication interface 1500, a user interface 1600, or a speaker 1700 shown in FIG. 13 to be described below, however, the components of the oven 100 are not limited thereto.

Referring to FIG. 1, the main body 101 forms the exterior of the oven 100. The cooking chamber 102 is configured to open a front surface inside the main body 101. The door 103 is installed to open or close the cooking chamber 102.

The camera 110 shown in FIG. 1 is installed to obtain an image of the inside of the cooking chamber 102. For example, the camera 110 may be installed in the upper center of the cooking chamber 102. For example, the camera 110 may be installed on one side of the upper portion of the cooking chamber 102. For example, the camera 110 may be installed in a part of the inside of the cooking chamber 102. For example, the camera 110 may be installed on a part of the inside of the door 103. The camera 110 may have a structure that is not damaged by heat inside the cooking chamber 102. For example, the camera 110 may be installed in a recessed structure inside the cooking chamber 102. For example, the camera 110 may be installed in a recessed structure inside the door 103. For example, the camera 110 may be configured in the same structure as a thermal imaging camera. However, the present disclosure is not limited thereto.

The camera 110 shown in FIG. 1 may capture the image of the inside of the cooking chamber 102 as a still image or/and a moving image. The camera 110 may be a wide-angle camera having a field of view capable of capturing an internal space of the cooking chamber 102. However, the present disclosure is not limited thereto. The camera 110 may be an ultra-small camera or a pinhole camera. The camera 110 may have durability to withstand high heat and electromagnetic waves, and may also have a waterproof function. A coil heating wire may be wound around the camera 110 to prevent frost from occurring. An installation location of the camera 110 may be determined in consideration of an installation location of a heater 1310 included in the driving unit 1300 of FIG. 13 to be described below.

The camera 110 shown in FIG. 1 may have an auto exposure function. The camera 110 shown in FIG. 1 may perform an automatic exposure (AE) operation (e.g., an operation of performing an automatic exposure function) in real time when power is applied. However, the present disclosure is not limited thereto. For example, the camera 110 may perform the AE operation when the door 103 of the oven 100 is closed or according to a user request. The user request may include a request for monitoring the cooking chamber 102 of the oven 100 or a request for performing an AI object recognition function. However, the present disclosure is not limited thereto. An AI object recognition function request may refer to an object recognition request inside the cooking chamber 102. An object inside the cooking chamber 102 may include food or food ingredients. However, the present disclosure is not limited thereto. The object recognition request may include a food recognition request.

The AE operation of the camera 110, according to an embodiment of the present disclosure, is a function for obtaining a high quality image by maintaining an appropriate exposure value according to a change in light entering through a lens included in the camera 110. For example, the AE operation of the camera 110 is a function of constantly maintaining the brightness of light received by an image sensor included in the camera 110 by automatically adjusting a shutter speed even when the ambient light of the camera 110 changes. Due to the AE operation of the camera 110, a user may easily obtain a high quality image without a separate manipulation. The AE operation of the camera 110 may be referred to as being performed by the image sensor included in the camera 110.

When the AE operation is in a stable state, the camera 110 shown in FIG. 1 may store information indicating that the AE operation is in the stable state and an exposure value when the AE operation is in the stable state. The stable state of the AE operation of the camera 110 may refer to a state in which the camera 110 may consistently maintain desired brightness and color levels by selecting appropriate illuminance and exposure time. For example, the stable state of the AE operation of the camera 110 may refer to a state in which an image distributed in a middle value is obtained when a histogram of a brightness distribution of the image obtained by the camera 110 is expressed from 0 to 255.

According to an embodiment of the present disclosure, the information indicating that the AE operation of the camera 110 is in the stable state and the exposure value (e.g., when the AE operation is in the stable state) in this regard may be stored in an image signal processor (ISP) included in the camera 110. However, the present disclosure are not limited thereto. When the information indicating that the AE operation of the camera 110 is in the stable state and stored in the ISP is expressed as ‘1’, information indicating that the AE operation is in a non-stable state may be expressed as ‘0’.

According to an embodiment of the present disclosure, the non-stable state of the AE operation of the camera 110 may refer to a state in which an image distributed at a small value (e.g., an overexposed image) is obtained when the histogram of the brightness distribution of the image obtained by the camera 110 is expressed from 0 to 255 or an image distributed at a large value (e.g., an underexposed image) is obtained when the histogram of the brightness distribution of the image obtained by the camera 110 is expressed from 0 to 255.

For example, the camera 110 may perform the AE operation of detecting and maintaining an optimal exposure value by using a mean value algorithm. For example, the camera 110 may perform the AE operation of detecting and maintaining the optimal exposure value by using an algorithm that uses an intermediate pixel value as a brightness mean value among all pixel values of a captured image. The optimal exposure value may be an exposure value suitable for the user to monitor the cooking chamber 102 based on the image obtained by the camera 110. The optimal exposure value may be an exposure value suitable for recognizing an object inside the cooking chamber 102 by using the AI object recognition function based on the image obtained by the camera 110.

Even when the camera 110, according to an embodiment of the present disclosure, optimizes brightness during capturing by performing an AE operation, an exposure value in which the AE operation is in the stable state may be vary depending on ambient brightness conditions.

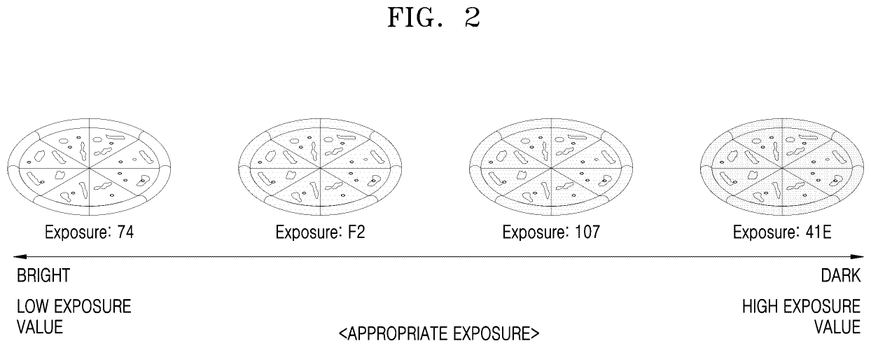

FIG. 2 is a diagram illustrating a relationship between ambient brightness of the camera 110 and an appropriate exposure value when an AE operation of the camera 110 is in a stable state, according to an embodiment of the present disclosure.

Referring to FIG. 2, when the ambient brightness around the camera 110 is brighter, the exposure value is lower in the stable state of the AE operation, and when the ambient brightness around the camera 110 is darker, the exposure value is higher in the stable state of the AE operation.

For example, when the ambient brightness of the camera 110 changes from bright to dark, the appropriate exposure value may be, for example, between hexadecimal values, 0×74, 0×F2, 0×107, 0×41E in the stable state of the AE operation of the camera 110. However, the present disclosure is not limited thereto. That the ambient brightness around the camera 110 is bright may indicate that a brightness level inside the cooking chamber 102 of the oven 100 is high. That ambient brightness around the camera 110 is dark may indicate that the brightness level inside the cooking chamber 102 of the oven 100 is low. The criterion for determining whether the brightness level inside the cooking chamber 102 of the oven 100 is a high level or a low level may be set based on whether the image captured by the camera 110 is bright or dark enough for a user (user's eyes) to monitor the cooking chamber 102 of the oven 100. However, the present disclosure is not limited thereto. For example, the criterion for determining whether the brightness level inside the cooking chamber 102 of the oven 100 is the high level or the low level may be set based on whether the image captured by the camera 110 is bright or dark enough to perform an AI object recognition function.

The lamp 120 shown in FIG. 1 is installed at a location adjacent to the camera 110. A brightness level of the lamp 120 may be controlled based on an exposure value of the camera 110. The lamp 120 is described with reference to FIGS. 3 and 13.

The oven 100 shown in FIG. 1 may obtain an image of the cooking chamber 102 by using the camera 110 during cooking. The oven 100 may obtain an image of the inside of the cooking chamber 102 by using the camera 110 according to a user's request regardless of cooking. According to an embodiment of the present disclosure, the user's request may be received by direct control with respect to the oven 100. Alternatively or additionally, the user's request may also be received remotely through a user terminal 200. Direct control with respect to the oven 100 may be performed by using the user interface 1600 included in the oven 100. However, the present disclosure is not limited thereto. The user request may include a request for monitoring the cooking chamber 102 or a request for performing the AI object recognition function. However, the present disclosure is not limited thereto. When the door 103 for opening or closing the cooking chamber 102 is closed, the oven 100 may obtain an image of the inside of the cooking chamber 102 after performing an AE operation by using the camera 110.

According to an embodiment of the present disclosure, the oven 100 shown in FIG. 1 may also perform communication to transmit and receive data with the user terminal 200 and a server device 300. According to an embodiment of the present disclosure, the oven 100 may transmit identification information of the oven 100 or user identification information (e.g., login information, and account information) to the server device 300. The server device 300 may authenticate the oven 100 based on the received identification information of the oven 100 or user identification information, transmit an authentication result to the oven 100, and allow access of the server device 300 to the oven 100.

The oven 100 may request the server device 300 to update software related to the oven 100 as access from the server device 300 is allowed. Software related to the oven 100 may include software related to the camera 110. For example, the software related to the oven 100 may include software that controls the brightness level of the lamp 120 according to the exposure value of the camera 110. For example, the software related to the oven 100 may include software that controls the brightness level of the lamp 120 according to the brightness value (or illuminance value) of the cooking chamber 102 measured by the illuminance sensor 130 to be mentioned in FIG. 12.

The server device 300 may include a communication interface for performing communication with an external device. The server device 300 may perform communication with the oven 100 or the user terminal 200 through the communication interface. The server device 300 may update the software of the oven 100 based on communication with the oven 100. Alternatively or additionally, the server device 300 may transmit the updated software related to the oven 100 based on communication with the user terminal 200.

According to an embodiment of the present disclosure, the server device 300 may include an AI processor. The AI processor may train the AI model with respect to the camera 110 of the oven 100 by inputting the exposure value of the camera 110 and brightness level information of the lamp 120 to the AI model with respect to the camera 110 of the oven 100. Training the AI model may mean generating a mathematical model that may make an optimal decision while appropriately changing weights based on input data.

The user terminal 200, according to an embodiment of the present disclosure, may be connected to the server device 300, and may update the software of the oven 100 or wirelessly (or remotely) control an operation of the oven 100 based on a program provided from the server device 300. For example, the user terminal 200 may transmit and receive information to and from the server device 300 through a specific application (e.g., a management application of the oven 100) installed in the user terminal 200. For example, the user terminal 200 may display the image of the cooking chamber 102 obtained by the camera 110 of the oven 100 through the specific application installed in the user terminal 200 and control the brightness level of the lamp 120 based on the displayed image of the cooking chamber 102.

According to an embodiment of the present disclosure, the user terminal 200 may be connected to the server device 300 by using the same user identification information (e.g., login information and account information) as the oven 100. The user terminal 200 may be directly connected to the oven 100 through a short-distance wireless communication channel, or may be indirectly connected to the oven 100 through the server device 300.

The user terminal 200, according to an embodiment of the present disclosure, may be implemented in various forms. For example, the user terminal 200 described in the present disclosure may be a mobile terminal, a vehicle, a refrigerator including a display, a TV, or a computer. However, the present disclosure is not limited thereto. In addition, the mobile terminal may include a smart phone, a laptop computer, a tablet PC, a digital camera, an electronic book terminal, a digital broadcasting terminal, a personal digital assistant (PDA), a portable multimedia player (PMP), navigation, or an MP3 player. However, the present disclosure is not limited thereto. For example, the mobile terminal may be a wearable device that may be worn by a user.

According to an embodiment of the present disclosure, the user terminal 200 or the oven 100 may receive a voice signal, which is an analog signal, through a microphone, and convert a voice part into computer-readable text by using an automatic speech recognition (ASR) model. The user terminal 200 or the oven 100 may obtain an utterance intention of the user by interpreting the converted text by using a natural language understanding (NLU) model. Here, the ASR model or an NLU model may be an AI model. The AI model may be processed by an AI dedicated processor designed with a hardware structure specialized in the processing of the AI model. The AI model may be generated through learning. Such learning may be performed in a device itself (e.g., the user terminal 200 or the oven 100) on which the AI, according to the present disclosure, is performed, or may be performed through the separate server device 300 and/or system. Examples of a learning algorithm may include supervised learning, unsupervised learning, semi-supervised learning, or reinforcement learning. However, the present disclosure are not limited to the above-described examples.

According to an embodiment of the present disclosure, the user terminal 200 may execute the specific application (e.g., the management application of the oven 100) provided by the server device 300 based on a user input. In this case, the user may control the operation of the oven 100 through an execution screen of the application and check a monitoring image or a cooking process image of an internal space of the oven 100 (e.g., inside the cooking chamber 102). The user terminal 200 and the server device 300 shown in FIG. 1 may be expressed as external devices of the oven 100.

FIG. 3 is a functional block diagram of the oven 100, according to an embodiment of the present disclosure. The oven 100 shown in FIG. 3 may include the camera 110, the lamp 120, a processor 310, and a memory 320, however, all of the components shown in FIG. 3 are not indispensable components of the oven 100.

The camera 110 as shown in FIG. 3 may capture the inside (or internal space) of the cooking chamber 102 as mentioned in FIG. 1, and may include an AE function. When power is applied, the camera 110 may perform an AE operation. When the AE operation is stable, the camera 110 may store information indicating that the AE operation is in a stable state and an exposure value when the AE operation is in the stable state, and transfer the stored information and the exposure value to the processor 310 according to a request of the processor 310.

The processor 310 as shown in FIG. 3 may execute one or more instructions stored in the memory 320 to control all functions of the oven 100. The processor 310 may execute the one or more instructions stored in the memory 320 to monitor the inside of the cooking chamber 102 of the oven 100 based on an image obtained by the camera 110 or perform an AI object recognition function. Because the processor 310 may be configured in plural, according to an embodiment, the processor 310 may be expressed as at least one processor. For example, the processor 310 may include a main processor and a sub processor.

The processor 310 shown in FIG. 3 may obtain the information indicating that the AE operation of the camera 110 is in the stable state and the exposure value in this regard. The processor 310 may simultaneously obtain the information indicating that the AE operation is in the stable state and the exposure value in this regard from the camera 110. Alternatively or additionally, the processor 310 may obtain the exposure value in this regard after reading the information indicating that the AE operation is in the stable state. An operation performed by the processor 310 of obtaining the information indicating that the AE operation is in the stable state and the exposure value in this regard from the camera 110 may be expressed as an operation performed by the processor 310 of reading the information indicating that the AE operation is in the stable state and the exposure value in this regard from the camera 110.

The processor 310 of FIG. 3 may be connected to the camera 110 through a universal serial bus (USB) communication method. However, the present disclosure is not limited thereto. Accordingly, the camera 110 may be expressed as including a communication interface for transmitting and receiving data with the processor 310.

The processor 310 shown in FIG. 3 may periodically obtain the information indicating that the AE operation is in the stable state stored in the camera 110 and the exposure value in this regard. The processor 310 may obtain the information indicating that the AE operation is in the stable state stored in the camera 110 and the exposure value in this regard after power is applied to the camera 110 and power is applied to the lamp 120, and then, the AE operation is performed by the camera 110. Applying power to the camera 110 and the lamp 120 may mean that the operation of the camera 110 and the operation of the lamp 120 are switched from an off state to an on state. Applying power to the camera 110 and the lamp 120 may mean that the operation of the camera 110 and the operation of the lamp 120 are set to be the on state.

The processor 310 shown in FIG. 3 may identify whether the AE operation of the camera 110 is in the stable state based on the information indicating that the AE operation is in the stable state obtained from the camera 110.

When it is identified that the AE operation of the camera 110 is in the stable state, the processor 310 shown in FIG. 3 may obtain an exposure value from the camera 110 when the AE operation is in the stable state. The processor 310 may compare the obtained exposure value with a preset reference exposure value. The preset reference exposure value (or a preset first value or a preset value) may include appropriate exposure period information. For example, the preset reference exposure value may be determined based on object recognition of the cooking chamber 102. For example, the preset reference exposure value may be an exposure value determined as an optimal exposure value for a user to monitor the cooking chamber 102. For example, the preset reference exposure value may be an exposure value determined as the optimal exposure value for recognizing an object inside the cooking chamber 102 by using an AI object recognition function. For example, the preset reference exposure value may be set from F0 to FF. For example, the preset reference exposure value may be F2 which is one appropriate exposure value. However, the present disclosure is not limited thereto.

The processor 310 shown in FIG. 3 may control a brightness level of the lamp 120 based on a result of comparing the exposure value with the preset reference exposure value. The lamp 120 may emit light to the cooking chamber 102. As shown in FIG. 1, the lamp 120 may be installed at a location adjacent to the camera 110. However, the present disclosure is not limited thereto.

As a result of comparing the exposure value with the preset reference exposure value, when the exposure value is greater than the preset reference exposure value, the processor 310 shown in FIG. 3 may identify that brightness inside the cooking chamber 102 is in a dark state. Accordingly, the processor 310 may control the brightness level of the lamp 120 so that the brightness of the lamp 120 becomes bright. Controlling the brightness level of the lamp 120 so that the brightness of the lamp 120 becomes bright may mean increasing the brightness level of the lamp 120. The brightness level of the lamp 120 may be expressed as a lux (e.g., 1×) value corresponding to numerical information (e.g., 1, 2, . . . , n, where n is a positive integer greater than zero (1)). However, the present disclosure is not limited thereto.

As a result of comparing the exposure value with the preset reference exposure value, when the exposure value is less than the preset reference exposure value, the processor 310 shown in FIG. 3 may identify that the brightness inside the cooking chamber 102 is in a bright state. Accordingly, the processor 310 may control the brightness level of the lamp 120 so that the brightness of the lamp 120 becomes dark. Controlling the brightness level of the lamp 120 so that the brightness of the lamp 120 becomes dark may mean decreasing the brightness level of the lamp 120.

As a result of comparing the exposure value with the preset reference exposure value, when the exposure value corresponds to the preset reference exposure value, the processor 310 shown in FIG. 3 may identify that the brightness inside the cooking chamber 102 is appropriate for recognizing the object. Accordingly, the processor 310 may control the camera 110 to obtain an image of the inside of the cooking chamber 102. Controlling the camera 110 to obtain the image of the inside of the cooking chamber 102 may mean activating a capturing operation of the camera 110.

The processor 310 shown in FIG. 3 may control the brightness level of the lamp 120 by using a pulse width modulation (PWM) signal. Controlling the brightness level of the lamp 120 may mean controlling illuminance of light emitted from the lamp 120. However, the present disclosure is not limited thereto. For example, controlling the brightness level of the lamp 120 may include controlling luminance and color of the light emitted from the lamp 120.

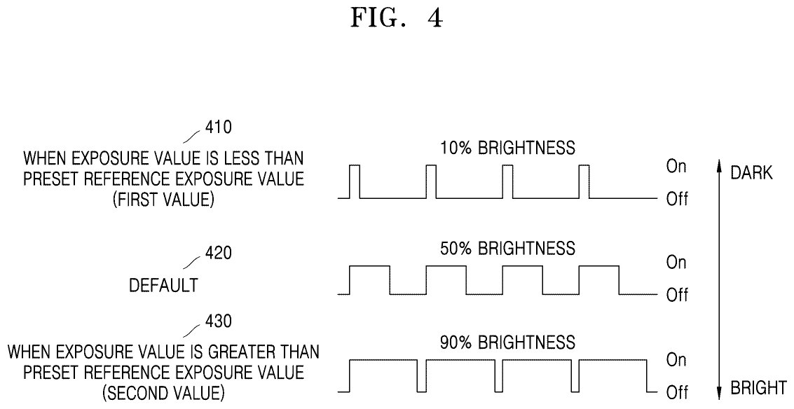

FIG. 4 is a diagram of a PWM signal transmitted from the processor 310 to the lamp 120 to control a brightness level of the lamp 120, according to an embodiment of the present disclosure.

Referring to FIG. 4, as a result of comparing an obtained exposure value with a preset reference exposure value, when the exposure value is less than the preset reference exposure value (operation 410), the processor 310 may control the brightness level of the lamp 120 to decrease by decreasing an on period of a pulse width of a PWM transmitted to the lamp 120 than an on period set as a default (operation 420). Accordingly, brightness of the cooking chamber 102 may be darker than previous brightness. A period of PWM set as the default (operation 420) may be a period of the PWM signal transmitted from the processor 310 to the lamp 120 when the obtained exposure value corresponds to the preset reference exposure value (a preset first value).

Referring to FIG. 4, as a result of comparing the obtained exposure value with the preset reference exposure value, when the exposure value is greater than the preset reference exposure value (operation 430), the processor 310 may control the brightness level of the lamp 120 to increase by increasing the on period of the pulse width of the PWM transmitted to the lamp 120 than the on period set as the default (operation 420). Accordingly, the brightness of the cooking chamber 102 may be brighter than the previous brightness.

In FIG. 4, decreasing or increasing the on period of the PWM pulse width may refer to decreasing (e.g., adjusting from 50% brightness pulse width to 10% brightness pulse width) or increasing (e.g., adjusting from 50% brightness pulse width to 90% brightness pulse width) a duty ratio to the brightness.

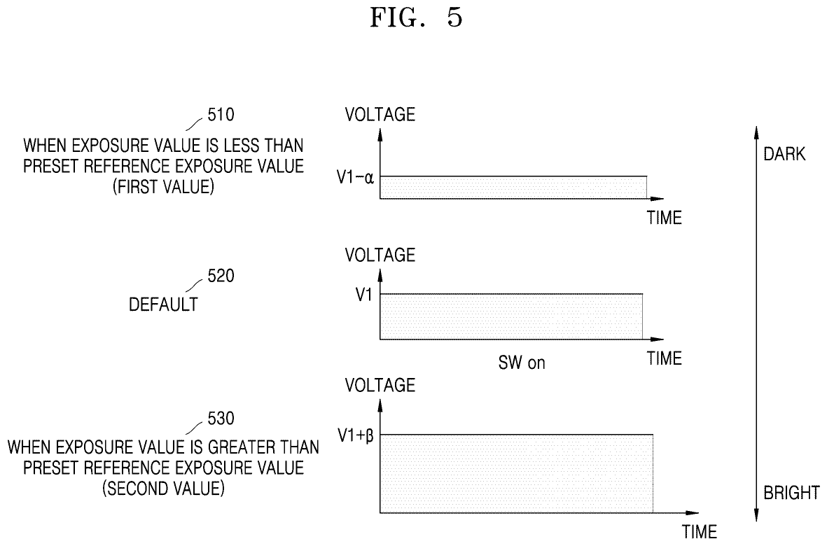

FIG. 5 is a diagram of a direct current (DC) voltage value transmitted from the processor 310 to the lamp 120 to control a brightness level of the lamp 120, according to an embodiment of the present disclosure.

Referring to FIG. 5, as a result of comparing an obtained exposure value with a preset reference exposure value, when the exposure value is less than the preset reference exposure value (510), the processor 310 may control the brightness level of the lamp 120 to decrease by decreasing (V1−α) the DC voltage value transmitted to the lamp 120 than a voltage value V1 set as a default (520). Here, a may be an experimentally obtained constant. Accordingly, brightness of the cooking chamber 102 may be darker than previous brightness. The DC voltage value V1 set as the default 520 may be a DC voltage value transmitted from the processor 310 to the lamp 120 when the obtained exposure value corresponds to the preset reference exposure value (e.g., a preset first value).

Referring to FIG. 5, as a result of comparing an obtained exposure value with a preset reference exposure value, when the exposure value is greater than the preset reference exposure value (530), the processor 310 may control the brightness level of the lamp 120 to increase by increasing (V1+ß) the DC voltage value transmitted to the lamp 120 than the voltage value V1 set as the default (520). Here, ß may be an experimentally obtained constant. Accordingly, the brightness of the cooking chamber 102 may be brighter than the previous brightness.

In FIG. 5, decreasing or increasing the DC voltage value may refer to decreasing (e.g., adjusting from 5 V DC voltage value to 4 V DC voltage value) or increasing (e.g., adjusting from 5 V DC voltage value to 6 V DC voltage value) the voltage value corresponding to the brightness.

When the exposure value obtained from the camera 110 corresponds to the preset reference exposure value (the preset first value), the processor 310 may identify that the brightness level of a lamp inside the cooking chamber 102 is appropriate. Accordingly, the processor 310 may activate a capturing operation of the camera 110 while maintaining the brightness of the lamp 120. The preset reference exposure value may be obtained and stored through an experiment during product manufacturing. The preset reference exposure value may be changed by a user based on an image obtained by capturing the cooking chamber 102 of the oven 100. Accordingly, the preset reference exposure value may be set to a different value according to the user. The oven 100 may provide guide information when the user sets the preset reference exposure value. The guide information may include a value selected by the user (e.g., a reference exposure value to be compared with the exposure value) and an image of the inside of the cooking chamber 102 corresponding to the selected value (e.g., the reference exposure value to be compared with the exposure value). Accordingly, the user may obtain the image of the inside of the cooking chamber 102 having a brightness level suitable for the user based on the provided guide information.

The memory 320 may store various information including the preset reference exposure value. The memory 320 may store at least one instruction. The processor 310 may read and execute one or more instructions stored in the memory 320. The memory 320 may store information obtained by mapping the pulse width information (e.g., duty ratio information of a brightness pulse) of the PWM signal shown in FIG. 4 and the exposure value. For example, when the lamp 120 is turned on regardless of the operation of the oven 100, pulse width information of the PWM signal provided from the processor 310 to the lamp 120 (e.g., information with 50% of a duty ratio of the brightness pulse) may be set as default pulse width information, and a table mapping exposure values of the camera 110 based on the preset reference exposure value and the pulse width information of the PWM signal provided to the lamp 120 may be stored in the memory 320.

The memory 320 may include at least one type of storage medium among a flash memory type memory, a hard disk type memory, a multimedia card micro type, a card type memory (e.g., SD or XD memory), a random access memory (RAM), a static random access memory (SRAM), a read-only memory (ROM), an electrically erasable read-only memory (EEPROM), a programmable read-only memory (PROM), a magnetic memory, a magnetic disk, or an optical disk.

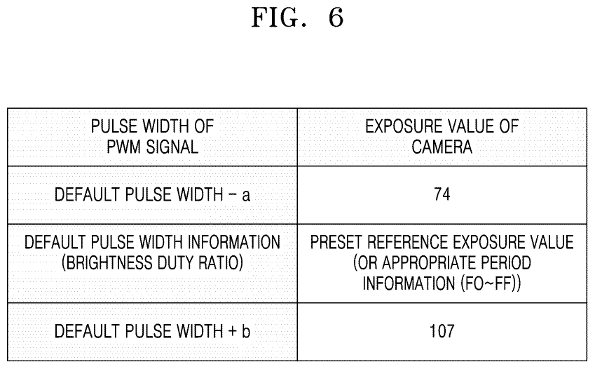

FIG. 6 illustrates an example of a table mapping pulse width information of a PWM signal for controlling the brightness of the lamp 120 and an exposure value of the camera 110, according to an embodiment of the present disclosure. However, the relationship between the pulse width information of the PWM signal and the exposure value of the camera 110 is not limited to that shown in FIG. 6. a and b shown in FIG. 6 may be integers indicating a duty ratio corresponding to the brightness of a PWM pulse width. For example, a may be set to 40, and b may have the same value as 40. However the present disclosure is not limited in this regard, and a and b may also have different values.

Referring to the table shown in FIG. 6, when the pulse width information of the PWM signal is a default pulse width-a, the exposure value of the camera 110 is mapped to 74. When the pulse width information of the PWM signal is default pulse width information (50% of the brightness duty ratio), the exposure value of the camera 110 is mapped to the preset reference exposure value F0 to FF (or appropriate period information). When the pulse width information of the PWM signal is a default pulse width+b, the exposure value of the camera 110 is mapped to 107.

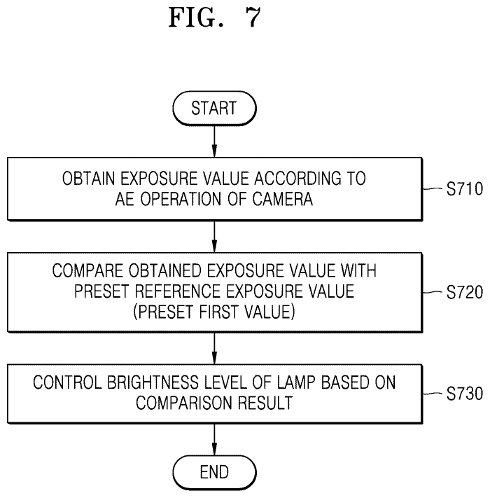

FIG. 7 is a flowchart of a method of operating the oven 100, according to an embodiment of the present disclosure.

In operation S710 of FIG. 7, the processor 310 of the oven 100 obtains an exposure value according to an AE operation of the camera 110. The exposure value according to the AE operation of the camera 110 is an exposure value after the AE operation of the camera 110 is stable. The exposure value of the camera 110 may be obtained from the camera 110 by the processor 310.

In operation S720 of FIG. 7, the processor 310 of the oven 100 may compare the obtained exposure value with a preset reference exposure value (or a preset first value). The preset reference exposure value may include appropriate exposure period information. For example, the preset reference exposure value may be determined based on object recognition of the cooking chamber 102. For example, the preset reference exposure value may be an exposure value determined as an optimal exposure value for a user to monitor the cooking chamber 102. For example, the preset reference exposure value may be an exposure value determined as the optimal exposure value for recognizing an object of the cooking chamber 102 by using an AI object recognition function. For example, the preset reference exposure value may be set from F0 to FF. For example, the preset reference exposure value may be F2 which is one appropriate exposure value. However, the present disclosure is not limited thereto.

In operation S730 of FIG. 7, the processor 310 of the oven 100 may control a brightness level of the lamp 120 based on a comparison result. For example, the oven 100 may control the brightness level of the lamp 120 to allow the exposure value of the camera 110 to correspond to the preset reference exposure value. For example, when the exposure value of the camera 110 is greater than the preset reference exposure value, the processor 310 of the oven 100 may identify that brightness of the cooking chamber 102 is dark to recognize an object inside the cooking chamber 102. Accordingly, the processor 310 of the oven 100 may control the brightness level of the lamp 120 so that the brightness of the lamp 120 increases. For example, the processor 310 may control the brightness level of the lamp 120 to increase by extending an on period pulse width of a PWM signal transmitted to the lamp 120 or increasing a DC voltage value transmitted to the lamp 120. For example, when the exposure value of the camera 110 is less than the preset reference exposure value, the processor 310 of the oven 100 may identify that the brightness of the cooking chamber 102 is bright to recognize the object inside the cooking chamber 102. Accordingly, the processor 310 of the oven 100 may control the brightness level of the lamp 120 so that the brightness of the lamp 120 decreases. For example, the processor 310 may control the brightness level of the lamp 120 to decrease by reducing the on period pulse width of the PWM signal transmitted to the lamp 120 or decreasing the DC voltage value transmitted to the lamp 120.

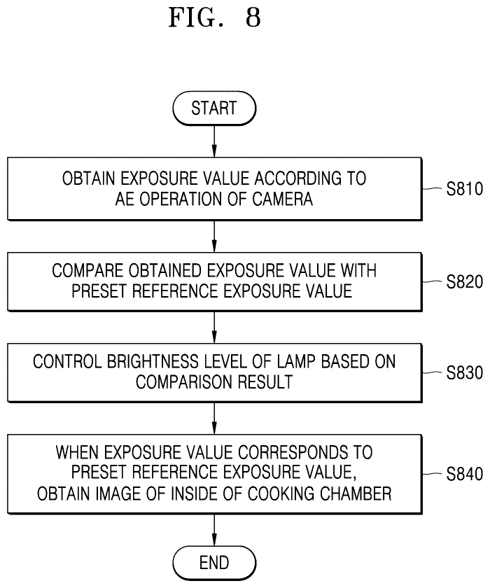

FIG. 8 is a flowchart of a method of operating the oven 100, according to an embodiment of the present disclosure.

In operation S810 of FIG. 8, the processor 310 of the oven 100 may obtain an exposure value according to an AE operation of the camera 110. The exposure value according to the AE operation of the camera 110 may be an exposure value after the AE operation of the camera 110 is stable. The exposure value of the camera 110 may be obtained from the camera 110 by the processor 310.

In operation S820 of FIG. 8, the processor 310 of the oven 100 may compare the obtained exposure value with a preset reference exposure value (or a preset first value). The preset reference exposure value may include appropriate exposure period information. For example, the preset reference exposure value may be determined based on object recognition of the cooking chamber 102. For example, the preset reference exposure value may be an exposure value determined as an optimal exposure value for a user to monitor the cooking chamber 102. For example, the preset reference exposure value may be an exposure value determined as the optimal exposure value for recognizing an object inside the cooking chamber 102 by using an AI object recognition function. For example, the preset reference exposure value may be set from F0 to FF. For example, the preset reference exposure value may be F2 which is one appropriate exposure value. However, the present disclosure is not limited thereto.

In operation S830 of FIG. 8, the processor 310 of the oven 100 may control a brightness level of the lamp 120 based on a comparison result. For example, the processor 310 of the oven 100 may control the brightness level of the lamp 120 so that the exposure value of the camera 110 corresponds to the preset reference exposure value. For example, when the exposure value of the camera 110 is greater than the preset reference exposure value, the processor 310 of the oven 100 may identify (or determine) that brightness of the cooking chamber 102 is dark to recognize an object inside the cooking chamber 102. Accordingly, the processor 310 of the oven 100 may control the brightness level of the lamp 120 so that the brightness of the lamp 120 increases. For example, the processor 310 may control the brightness level of the lamp 120 to increase by extending an on period pulse width of a PWM signal transmitted to the lamp 120 or increasing a DC voltage value transmitted to the lamp 120. For example, when the exposure value of the camera 110 is less than the preset reference exposure value, the processor 310 of the oven 100 may identify (or determine) that the brightness of the cooking chamber 102 is bright to recognize the object inside the cooking chamber 102. Accordingly, the processor 310 of the oven 100 may control the brightness level of the lamp 120 so that the brightness of the lamp 120 decreases. For example, the processor 310 may control the brightness level of the lamp 120 to decrease by reducing the on period pulse width of the PWM signal transmitted to the lamp 120 or decreasing the DC voltage value transmitted to the lamp 120.

In operation S840 of FIG. 8, when the exposure value of the camera 110 corresponds to the preset reference exposure value, the processor 310 of the oven 100 may identify (or determine) that the brightness of the cooking chamber 102 is appropriate for recognizing the object inside the cooking chamber 102. Accordingly, the processor 310 of the oven 100 may obtain an image of the cooking chamber 102 by controlling a capturing operation of the camera 110 to be activated.

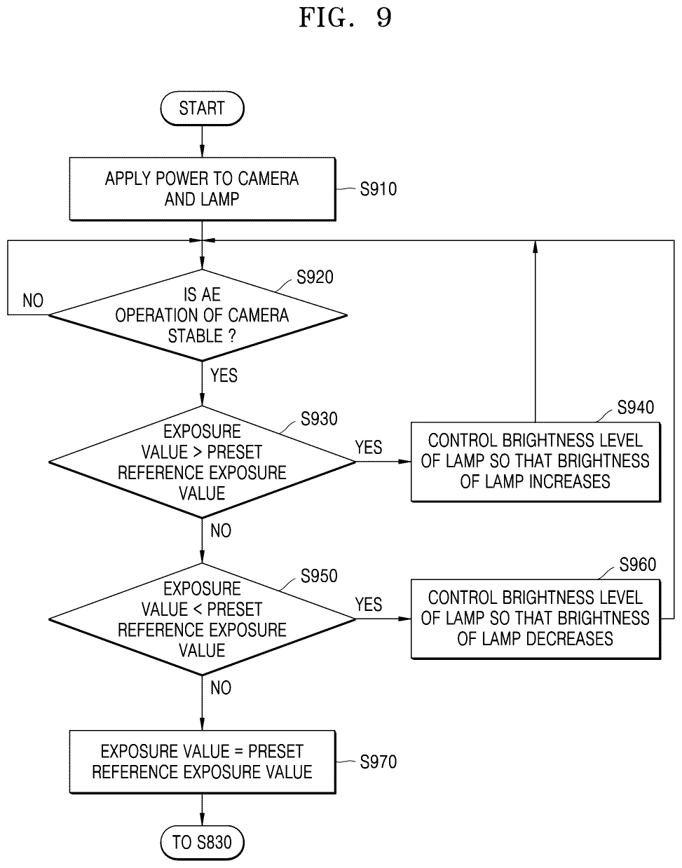

FIG. 9 is a flowchart of a method of operating the oven 100, according to an embodiment of the present disclosure.

In operation S910 of FIG. 9, the processor 310 of the oven 100 may control an operation of the oven 100 so that power is applied to the camera 110 and the lamp 120. Accordingly, the camera 110 may perform an AE operation, and the lamp 120 may emit light set as default.

In operation S920 of FIG. 9, the processor 310 of the oven 100 may identified whether the AE operation of the camera 110 is in a stable state. The processor 310 may obtain information indicating that the AE operation is in the stable state stored in the camera 110 from the camera 110 to identify whether the AE operation of the camera 110 is in the stable state. For example, when the information indicating whether the AE operation is in the stable state obtained from the camera 110 is “1”, the processor 310 may determine that the AE operation of the camera 110 is in the stable state. When the information indicating whether the AE operation is in the stable state obtained from the camera 110 is ‘0’, the processor 310 may identify that the AE operation of the camera 110 is in a non-stable state. Therefore, in operation S920, when it is determined that the AE operation of the camera 110 is in the non-stable state (NO in operation S920), the processor 310 may perform operation S920 until it is determined that the AE operation of the camera 110 is in the stable state. In this regard, when it is determined that the AE operation of the camera 110 is in the non-stable state for a certain period of time or longer, the processor 310 may output notification information in this regard through the oven 100, the user terminal 200, or the server device 300. The notification information may be output in the form of an audio or a message. When output in the form of the audio, the notification information may be output as an audio signal through the speaker 1700. When output in the form of the audio, the notification information may be output as an audio signal through a speaker included in the user terminal 200. When output in the form of the message, the notification information may be displayed through a display 1610. When output in the form of the message, the notification information may be displayed through a display included in the user terminal 200.

In operation S920, when it is determined that the AE operation of the camera 110 is in the stable state (YES in operation S920), in operation S930, the processor 310 may obtain an exposure value when the AE operation is in the stable state from the camera 110 and may compare the obtained exposure value with a preset reference exposure value. The preset reference exposure value may be referred to as preset appropriate exposure period information or a preset value (or a preset first value). The preset reference exposure value may be stored in the memory 320 during product manufacturing and used by the processor 310. The preset reference exposure value may be changed by a user.

As a result of comparing the exposure value with the preset reference exposure value in operation S930, when the exposure value is greater than the preset reference exposure value (YES in operation S930), the processor 310 may identify that a lamp of the cooking chamber 102 is a dark to recognize an object inside the cooking chamber 102. Accordingly, in operation S940, the processor 310 may control a brightness level of the lamp 120 so that brightness of the lamp 120 increases. For example, the processor 310 may control the brightness level of the lamp 120 so that the brightness of the lamp 120 increases. For example, the processor 310 may increase the brightness level of the lamp 120 by at least one step. After controlling the brightness level of the lamp 120, the operation of the processor 310 proceeds to operation S920 to again identify whether the AE operation of the camera 110 is in the stable state. Next, in operation S930 of FIG. 9, the processor 310 of the oven 100 may compare the exposure value according to the AE operation of the camera 110 with the preset reference exposure value. The exposure value according to the AE operation of the camera 110 is an exposure value when the AE operation of the camera 110 is stable. The exposure value of the camera 110 may be obtained from the camera 110 by the processor 310. The preset reference exposure value (or the preset first value) may include appropriate exposure period information. For example, the preset reference exposure value may be determined based on object recognition inside the cooking chamber 102. For example, the preset reference exposure value may be an exposure value determined as an optimal exposure value for a user to monitor the cooking chamber 102. For example, the preset reference exposure value may be an exposure value determined as the optimal exposure value for recognizing an object inside the cooking chamber 102 by using an AI object recognition function. For example, the preset reference exposure value may be set from F0 to FF. For example, the preset reference exposure value may be F2 which is one appropriate exposure value. However, the present disclosure is not limited thereto.

In operation S930, when the processor 310 identifies (determines) that the exposure value of the camera 110 is not greater than the preset reference exposure value (NO in operation S930), in operation S950, the processor 310 may identify whether the exposure value is less than the preset reference exposure value. In operation S950, when it is identified (determined) that the exposure value is less than the preset reference exposure value, the processor 310 may identify that the lamp of the cooking chamber 102 is bright to identify the object (YES in operation S950). Accordingly, in operation S960, the processor 310 may control the brightness level of the lamp 120 so that the brightness of the lamp 120 decreases. For example, the processor 310 may control the brightness level of the lamp 120 so that the brightness level of the lamp 120 decreases by at least one step. After controlling the brightness level of the lamp 120, the operation of the processor 310 may proceed to operation S920.

In operation S950, when the processor 310 identifies that the exposure value is not less than the preset reference exposure value (NO in operation S950), in operation S970, the processor 310 may identify whether the exposure value corresponds to the preset reference exposure value. In operation S970, when it is identified that the exposure value corresponds to the preset reference exposure value, the processor 310 may proceed to operation S830 to activate a capturing operation of the camera 110 and obtain an image of the inside of the cooking chamber 102.

When the door 103 of the oven 100 is opened, monitoring of the cooking chamber 102 is requested, or execution of the AI object recognition function is requested, the processor 310, according to an embodiment of the present disclosure, may perform operation S910 or operation S920.

The processor 310, according to an embodiment of the present disclosure, may perform a pre-tuning operation of controlling the brightness of the lamp 120 based on the exposure value according to the AE operation of the camera 110 before the operation of the oven 100, as shown in operations S910 to S970 of FIG. 9. However, during the operation of the oven 100, the processor 310 may periodically perform operations S910 to S970 to adaptively or actively control the brightness level of the lamp 120 according to the exposure value of the camera 110.

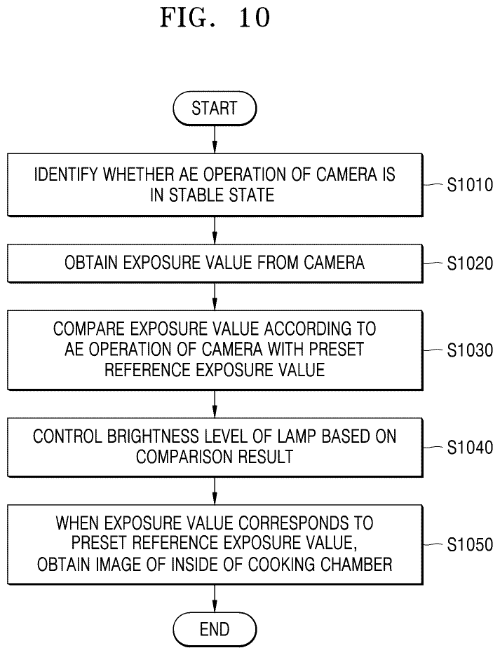

FIG. 10 is a flowchart of a method of operating the oven 100, according to an embodiment of the present disclosure.

In operation S1010 of FIG. 10, the processor 310 of the oven 100 identifies whether an AE operation of the camera 110 is in a stable state. The processor 310 may identify whether the AE operation of the camera 110 is in the stable state by obtaining information indicating whether the AE operation is in the stable state stored in the camera 110.

In operation S1020, the processor 310 of the oven 100 may obtain an exposure value from the camera 110. The processor 310 may obtain the exposure value from the camera 110 when the AE operation of the camera 110 is in the stable state.

In operation S1030, the processor 310 of the oven 100 may compare the exposure value according to the AE operation of the camera 110 with a preset reference exposure value. The preset reference exposure value is the preset reference exposure value (a preset first value) mentioned in operation S710 of FIG. 7. The exposure value according to the AE operation of the camera 110 may be obtained from the camera 110 by the processor 310.

In operation S1040, the processor 310 of the oven 100 may control a brightness level of the lamp based on a comparison result. For example, the oven 100 may control the brightness level of the lamp 120 so that the exposure value of the camera 110 corresponds to the preset reference exposure value. For example, when the exposure value of the camera 110 is greater than the preset reference exposure value, the processor 310 of the oven 100 may determine that brightness of the cooking chamber 102 is dark to recognize an object inside the cooking chamber 102. Accordingly, the processor 310 of the oven 100 may control the brightness level of the lamp 120 so that the brightness of the lamp 120 increases. For example, the processor 310 may control the brightness level of the lamp 120 to increase by extending an on period pulse width of a PWM signal transmitted to the lamp 120 or increasing a DC voltage value transmitted to the lamp 120. For example, when the exposure value of the camera 110 is less than the preset reference exposure value, the processor 310 of the oven 100 may identify that the brightness of the cooking chamber 102 is bright to recognize the object inside the cooking chamber 102. Accordingly, the processor 310 of the oven 100 may control the brightness level of the lamp 120 so that the brightness of the lamp 120 decreases. For example, the processor 310 may control the brightness level of the lamp 120 to decrease by reducing the on period pulse width of the PWM signal transmitted to the lamp 120 or decreasing the DC voltage value transmitted to the lamp 120.

In operation S1050 of FIG. 10, when the exposure value of the camera 110 corresponds to the preset reference exposure value, the processor 310 of the oven 100 may identify (determine) that the brightness of the cooking chamber 102 is appropriate for recognizing the object inside the cooking chamber 102. Accordingly, the processor 310 of the oven 100 may obtain an image of the inside of the cooking chamber 102 by controlling a capturing operation of the camera 110 to be activated.

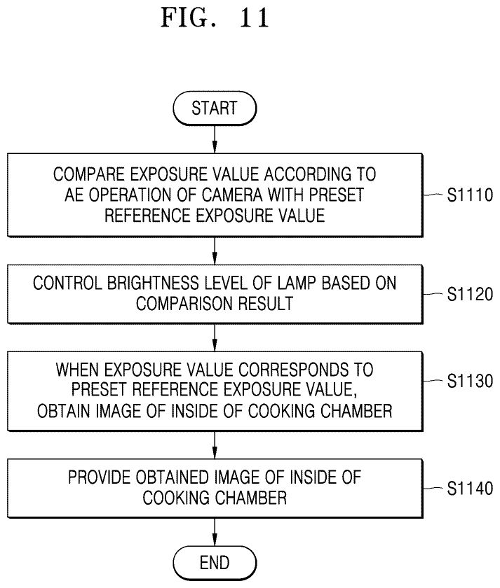

FIG. 11 is a flowchart of a method of operating the oven 100, according to an embodiment of the present disclosure.

In operation S1110 of FIG. 11, the processor 310 of the oven 100 may compare an exposure value according to an AE operation of the camera 110 with a preset reference exposure value. The exposure value according to the AE operation of the camera 110 is an exposure value when the AE operation of the camera 110 is stable. The exposure value of the camera 110 may be obtained from the camera 110 by the processor 310. The preset reference exposure value (or a preset first value) may include appropriate exposure period information. For example, the preset reference exposure value may be determined based on object recognition of the cooking chamber 102. For example, the preset reference exposure value may be an exposure value determined as an optimal exposure value for a user to monitor the cooking chamber 102. For example, the preset reference exposure value may be an exposure value determined as the optimal exposure value for recognizing an object inside the cooking chamber 102 by using an AI object recognition function. For example, the preset reference exposure value may be set from F0 to FF. For example, the preset reference exposure value may be F2 which is one appropriate exposure value. However, the present disclosure is not limited thereto.

In operation S1120 of FIG. 11, the processor 310 of the oven 100 may control the brightness level of the lamp 120 based on a comparison result. For example, the oven 100 may control the brightness level of the lamp 120 so that the exposure value of the camera 110 corresponds to the preset reference exposure value. For example, when the exposure value of the camera 110 is greater than the preset reference exposure value, the processor 310 of the oven 100 may identify that brightness of the cooking chamber 102 is dark to recognize an object inside the cooking chamber 102. Accordingly, the processor 310 of the oven 100 may control the brightness level of the lamp 120 so that the brightness of the lamp 120 increases. For example, the processor 310 may control the brightness level of the lamp 120 to increase by extending an on period pulse width of a PWM signal transmitted to the lamp 120 or increasing a DC voltage value transmitted to the lamp 120. For example, when the exposure value of the camera 110 is less than the preset reference exposure value, the processor 310 of the oven 100 may identify that the brightness of the cooking chamber 102 is bright to recognize the object inside the cooking chamber 102. Accordingly, the processor 310 of the oven 100 may control the brightness level of the lamp 120 so that the brightness of the lamp 120 decreases. For example, the processor 310 may control the brightness level of the lamp 120 to decrease by reducing the on period pulse width of the PWM signal transmitted to the lamp 120 or decreasing the DC voltage value transmitted to the lamp 120.

In operation S1130 of FIG. 11, when the exposure value of the camera 110 corresponds to the preset reference exposure value, the processor 310 of the oven 100 may determine that the brightness of the cooking chamber 102 is appropriate for recognizing the object inside the cooking chamber 102. Accordingly, the processor 310 of the oven 100 may obtain an image of the inside of the cooking chamber 102 by controlling a capturing operation of the camera 110 to be activated.

In operation S1140 of FIG. 11, the processor 310 of the oven 100 may provide the obtained image of the inside of the cooking chamber 102. For example, the oven 100 may provide the image of the inside of the cooking chamber 102 to the display 1610 included in the oven 100. Accordingly, the display 1610 may be controlled by the processor 310 to display the image of the inside of the cooking chamber 102. The user may easily and accurately check a cooking state of the cooking chamber 102 or a state inside the cooking chamber 102 based on the image of the inside of the cooking chamber 102 displayed on the display 1610 without opening the door 103 of the oven 100. For example, the oven 100 may transmit the image of the inside of the cooking chamber 102 to the user terminal 200 or the server device 300 through the communication interface 1500. Accordingly, the user may easily and accurately check the image of the inside of the cooking chamber 102 through a display of the user terminal 200. The user may control the brightness of the lamp of the cooking chamber 102 based on the image of the inside of the cooking chamber 102 through the user terminal 200.

The server device 300 may store history information (e.g., details information) related to the cooking chamber 102 of the oven 100 based on the received image of the inside of the cooking chamber 102, information about a time the image of the inside of the cooking chamber 102 is received, location information of the oven 100, or the like, and register the image of the inside of the cooking chamber 102 in the user terminal 200 or a social network service (SNS) account of the user according to setting of the user. The server device 300 may generate and store a detailed description (e.g., food names, cooking levels of food, and the amount of food) related to the image of the inside of the cooking chamber 102 based on a result of performing the AI object recognition function based on the received image of the inside of the cooking chamber 102, or provide the detailed description to the user terminal 200.

FIG. 12 is a diagram for explaining components of the oven 100, according to an embodiment of the present disclosure. FIG. 12 is an example of the oven 100 shown in FIG. 1 further including an illuminance sensor 130.

The illuminance sensor 130 of FIG. 12 may be configured to detect brightness of the cooking chamber 102. The illuminance sensor 130 may be installed to prevent light emitted from the lamp 120 from being directly incident on the illuminance sensor 130. The illuminance sensor 130 may be installed at a location adjacent to the camera 110. The illuminance sensor 130 may be configured in a recessed structure. The oven 100 may perform an AE operation of the camera 110 after controlling the brightness of the lamp 120 based on a brightness value (illuminance value) sensed by the illuminance sensor 130. As described above, by adjusting the brightness inside the cooking chamber 102 by using the illuminance sensor 130 before performing the AE operation of the camera 110, the time taken for the AE operation of the camera 110 to reach a stable state may be reduced.

FIG. 13 is a block diagram of a configuration of the oven 100, according to an embodiment of the present disclosure.

The oven 100 shown in FIG. 13 may include the driving unit 1300, the sensor unit 1400, the communication interface 1500, the user interface 1600, and the speaker 1700 in addition to the camera 110, the processor 310, the lamp 120, and the memory 320. However, not all of the components shown in FIG. 13 are indispensable components of the oven 100. The oven 100 may be referred to as a home appliance including the above-described components.

The camera 110 shown in FIG. 13 may be configured in the same way as the camera 110 shown in FIG. 1. For example, the camera 110 may be an ultra-small camera or a pinhole camera. The camera 110 may have durability to withstand high heat and electromagnetic waves, and may also have a waterproof function. A coil heating wire may be wound around the camera 110 to prevent frost from occurring. According to an implementation example, a plurality of cameras 110 may be installed in a space inside the cooking chamber 102 of the oven 100. An installation location of the camera 110 may be determined in consideration of an installation location of the heater 1310 included in the driving unit 1300.

The processor 310 shown in FIG. 13 may control the overall operations of the oven 100. The processor 310 may control the camera 110, the driving unit 1300, the sensor unit 1400, the communication interface 1500, the user interface 1600, the lamp 120, the memory 320, and the speaker 1700 by executing programs stored in the memory 320.

The processor 310, according to an embodiment of the present disclosure, may be equipped with an AI processor. The AI processor may be manufactured in the form of a dedicated hardware chip for artificial intelligence AI, or may be manufactured as part of an existing general-purpose processor (e.g., a CPU or an application processor) or a dedicated graphics processor (e.g., a GPU) and mounted in the oven 100.

The driving unit 1300, according to an embodiment of the present disclosure, may include the heater 1310, a convection fan 1320, and a cooling fan 1330. However, the present disclosure is not limited thereto. The heater 1310 may heat food in the cooking chamber 102. The heater 1310 may be an electric heater including an electrical resistor or a gas heater that generates heat by burning a gas. The convection fan 1320 is installed at the rear of the cooking chamber 102 to circulate air inside the cooking chamber 102 so that food may be evenly heated. A convection motor for driving the convection fan 1320 may be provided in the cooking chamber 102. In addition, a fan cover covering the convection fan 1320 may be provided in front of the convection fan 1320, and a through hole may be formed in the fan cover to allow air to flow. The cooling fan 1330 may be a centrifugal fan that sucks in air from the top and discharges the air in a radial direction. The cooling fan 1330 may be disposed in a cooling flow path. The cooling fan 1330 may include a rotating plate formed flat, a hub formed in the center of the rotating plate and combined with a rotating shaft of a cooling motor, and a plurality of wings formed from the center of the rotating plate to the edge. The hub may be formed in a conical shape with radius increasing toward the bottom. Therefore, the hub may diffuse the air sucked in from the top in the radial direction.

The sensor unit 1400, according to an embodiment of the present disclosure, may include a depth sensor 1410, a weight detection sensor 1420, an infrared sensor 1430, a humidity sensor 1440 sensing humidity of the internal space, a gas sensor 1450 sensing a degree of gas of the internal space, a temperature sensor 1460, and the illumination sensor 130. However, the present disclosure is not limited thereto. The illuminance sensor 130, as described in FIG. 12, may measure the illuminance inside the cooking chamber 102 before the AE operation of the camera 110 is performed. A function of each sensor may be intuitively inferred by one of ordinary skill in the art from its name, and thus, a detailed description thereof may be omitted.

The communication interface 1500, according to an embodiment of the present disclosure, may include one or more components for communicating between the oven 100 and the server device 300, or between the oven 100 and the user terminal 200. For example, the communication interface 1500 may include a short-distance communication unit 1510, a long-distance communication unit 1520, or the like. For example, the communication interface 1500 may transmit an image of the inside of the cooking chamber 102 to at least one of the server device 300 or the user terminal 200. The communication interface 1500 may transmit information, such as an operation control command of the oven 100, software related to the oven 100, and a set value related to the oven 100 (e.g., a preset reference exposure value (first value) and a preset reference brightness value (second value)), transmitted from the server device 300 or the user terminal 200 to the processor 310.

The short-distance wireless communication unit 1510 included in the communication interface 1500 may include a Bluetooth™ communication unit, a Bluetooth™ low energy (BLE) communication unit, a near field communication (NFC) unit, a wireless local area network (WLAN) (e.g., Wireless Fidelity (Wi-Fi)) communication unit, a Zigbee communication unit, an infrared data association (IrDA) communication unit, a Wi-Fi direct (WFD) communication unit, an ultra wideband (UWB) communication unit, an Ant+ communication unit, or the like. However, the present disclosure is not limited thereto.

The long-distance communication unit 1520 included in the communication interface 1500 may be used to communicate with a server device when the oven 100 is remotely controlled by the server device in an Internet of Things (IoT) environment. The long-distance communication unit 1520 may include the Internet, a computer network (e.g., LAN or WAN), and a mobile communication unit. The mobile communication unit may include a 3G module, a 4G module, a 5G module, an LTE module, an NB-IoT module, an LTE-M module, or the like. However, the present disclosure is not limited thereto.

The user interface 1600, according to an embodiment of the present disclosure, may include the display 1610 and a touch panel 1620. The display 1610 may be referred to as an output interface capable of outputting a video signal (e.g., an image or a message). The touch panel 1620 may be referred to as an input interface capable of inputting a user command. The display 1610 and the touch panel 1620 may be configured as a touch screen having a layer structure. Touch panel 1620 is for receiving an input from a user. The touch panel 1620 may be configured in at least one of a contact capacitive method, a pressure resistive film method, an infrared detection method, a surface ultrasonic conduction method, an integral tension measurement method, or a piezoelectric effect method. However, the present disclosure is not limited thereto.

The display 1610 may include at least one of a liquid crystal display, a thin film transistor-liquid crystal display, a light-emitting diode (LED), an organic light-emitting diode, a flexible display, a three-dimensional (3D) display, or an electrophoretic display. In addition, the oven 100 may include two or more displays 1610, according to an implementation, form of the oven 100. The user interface 1600 may include at least one of a rotary operation setting button, a keypad, a dome switch, a jog wheel, or a jog switch. However, the present disclosure is not limited thereto.

For example, the user interface 1600 may include a voice recognition module. For example, the oven 100 may receive a voice signal, which is an analog signal, through a microphone and convert a voice part into computer-readable text by using an ASR model. The oven 100 may obtain an utterance intention of the user by interpreting the converted text by using an NLU model. Here, the ASR model or the NLU model may be an AI model. The AI model may be processed by an AI dedicated processor designed with a hardware structure specialized in the processing of the AI model. The AI model may be generated through learning. Here, generating the AI model through learning may refer to creating a predefined operation rule or an AI model designed to perform a desired characteristic (or purpose) by training a basic AI model using a learning algorithm with a large amount of training data. The AI model may include a plurality of neural network layers. The plurality of neural network layers may respectively have a plurality of weight values, and may perform a neural network operation through an operation result of a previous layer and an operation between the plurality of weights.

According to an embodiment of the present disclosure, the display 1610 may be controlled by the processor 310 to output the image of the inside of the cooking chamber 102. The display 1610 may display information indicating whether an AE operation of the camera 110 is in a stable state, information indicating whether an automatic white Balance (AWE) is in the stable state, information about the amount of light entering a lens of the camera 110, an exposure value when the AE operation of the camera 110 is in the stable state, or an exposure value when the AE operation of the camera 110 is in a non-stable state. However, the display 1610 may not display the above-described information.

The speaker 1700 may be expressed as an audio output unit. The speaker 1700 may output audio data received from the communication interface 1500 or stored in the memory 320. In addition, the speaker 1700 may output an audio signal related to a function performed in the oven 100 as an audio or notification sound.

The lamp 120, according to an embodiment of the present disclosure, may be installed at a location adjacent to the camera 110. However, the present disclosure is not limited thereto. For example, the lamp 120 may be disposed on one surface of the internal space of the cooking chamber 102 of the oven 100, and may be expressed as an internal lamp. For example, the lamp 120 may be disposed on the ceiling of the cooking chamber 102 or on the top of the cooking chamber 102, or on the side surface of the cooking chamber 102. For example, the lamp 120 may be disposed at a corner of the top of the cooking chamber 102. The lamp 120 may be turned on when a door of the oven 100 is opened or the oven 100 operates. The lamp 120 may be protected by a glass cover. When a certain time elapses after the lamp 120 is turned on, the lamp 120 may be turned off. The lamp 120 may be turned off according to a request for stopping monitoring the inside of the cooking chamber 102 or a request for stopping AI object recognition. The lamp 120 may maintain a turn-on state when the camera 110 is operating.

The lamp 120, according to an embodiment of the present disclosure, may have various brightness steps. For example, the lamp 120 may be controlled by the processor 310 to configure a brightness step to emit light from a dark step to a bright step. The lamp 120 may be a halogen lamp or an LED lamp. However, the present disclosure is not limited thereto. The lamp 120 may have various colors.

The memory 320, according to an embodiment of the present disclosure, may store an AI model. For example, the memory 320 may store an AI model for object recognition, an AI model for recipe recommendation, or the like. The memory 320 may include at least one type of storage medium among a flash memory type memory, a hard disk type memory, a multimedia card micro type, a card type memory (e.g., SD or XD memory), a RAM, an SRAM, a ROM, an EEPROM, a PROM, a magnetic memory, a magnetic disk, or an optical disk.

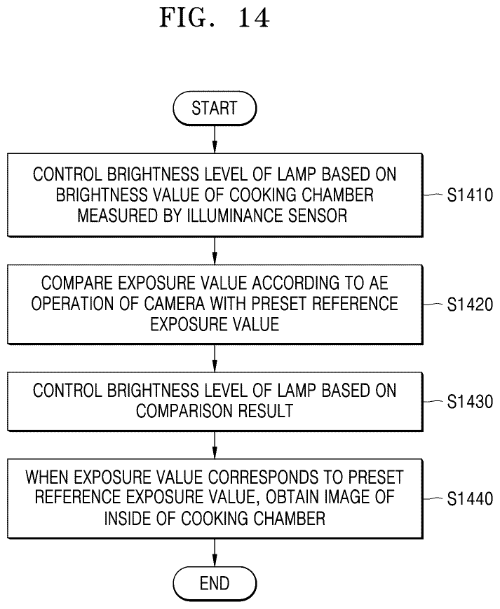

FIG. 14 is a flowchart of a method of operating the oven 100, according to an embodiment of the present disclosure.

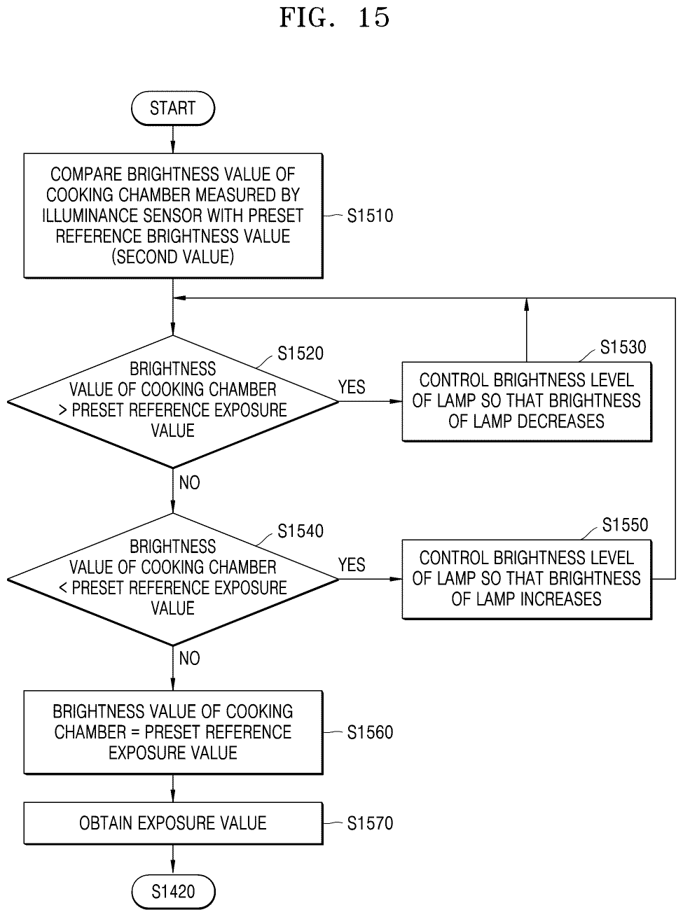

In operation S1410 of FIG. 14, the processor 310 of the oven 100 may control a brightness level of the lamp 120 based on illuminance (a brightness value of the cooking chamber 102) measured by the illuminance sensor 130. An operation of controlling the brightness level of the lamp 120 based on the brightness value of the cooking chamber 102 measured by the illuminance sensor 130 is described with reference to FIG. 15.

In operation S1420 of FIG. 14, the processor 310 of the oven 100 may compare an exposure value according to an AE operation of the camera 110 with a preset reference exposure value. The exposure value according to the AE operation of the camera 110 and the preset reference exposure value may be the same as described in operation S710 of FIG. 7. For example, the exposure value according to the AE operation of the camera 110 is an exposure value when the AE operation of the camera 110 is stable, and may be obtained from the camera 110. The preset reference exposure value, which is an exposure value most appropriate for recognizing an object inside the cooking chamber 102, may be obtained from the memory 320 or stored in the processor 310 to be used. The preset reference exposure value may be changed by a user.

In operation S1430 of FIG. 14, the processor 310 of the oven 100 may control the brightness level of the lamp 120 based on a result of comparing the exposure value according to the AE operation of the camera 110 with the preset reference exposure value. For example, as in operation S720 of FIG. 7 described above, when the exposure value of the camera 110 is greater than the preset reference exposure value, the processor 310 of the oven 100 may identify that brightness of the cooking chamber 102 is dark to recognize an object inside the cooking chamber 102. Accordingly, the processor 310 of the oven 100 may control the brightness level of the lamp 120 so that the brightness of the lamp 120 increases. For example, the processor 310 may control the brightness level of the lamp 120 to increase by extending an on period pulse width of a PWM signal transmitted to the lamp 120 or increasing a DC voltage value transmitted to the lamp 120. For example, when the exposure value of the camera 110 is less than the preset reference exposure value, the processor 310 of the oven 100 may identify that the brightness of the cooking chamber 102 is bright to recognize the object inside the cooking chamber 102. Accordingly, the processor 310 of the oven 100 may control the brightness level of the lamp 120 so that the brightness of the lamp 120 decreases. For example, the processor 310 may control the brightness level of the lamp 120 to decrease by reducing the on period pulse width of the PWM signal transmitted to the lamp 120 or decreasing the DC voltage value transmitted to the lamp 120.

In operation S1440 of FIG. 14, when the exposure value corresponds to the preset reference exposure value, the processor 310 of the oven 100 may identify that the brightness of the cooking chamber 102 is appropriate for recognizing the object inside the cooking chamber 102. Accordingly, the processor 310 of the oven 100 may obtain an image of the cooking chamber 102 by controlling a capturing operation of the camera 110 to be activated.

FIG. 15 is a flowchart of a method of operating the oven 100, according to an embodiment of the present disclosure.

In operation S1510 of FIG. 15, the processor 310 of the oven 100 may compare an illuminance value (e.g., a brightness value of the inside of the cooking chamber 102) measured by the illuminance sensor 130 with a preset reference brightness value (a second value). The brightness value of the inside of the cooking chamber 102 measured by the illuminance sensor 130 may be the brightness value of the inside of the cooking chamber 102 when the door 103 of the oven 100 is closed. However, the present disclosure is not limited thereto. For example, the brightness value of the inside of the cooking chamber 102 measured by the illuminance sensor 130 may refer to the brightness value of the inside of the cooking chamber 102 when power of the oven 100 is applied, before the camera 110 performs an AE operation, upon a request for monitoring the inside of the cooking chamber 102, or upon a request for AI object recognition inside the cooking chamber 102. The preset reference brightness value (the second value) may be a preset brightness value. The preset reference brightness value may have a brightness value capable of shortening an AE operation time of the camera 110 or reducing a time until reaching a brightness value appropriate for object recognition inside the cooking chamber 102. However, the present disclosure is not limited thereto.

In operation S1520 of FIG. 15, when it is identified that the brightness value of the cooking chamber 102 is greater than the preset reference brightness value (the preset second value) (YES in operation S1520), in operation S1530, the processor 310 of the oven 100 may control the brightness level of the lamp 120 so that the brightness of the lamp 120 decreases. In operation S1520 of FIG. 15, when the brightness value of the cooking chamber 102 is identified as not being greater than the preset reference brightness value (the preset second value) (NO in operation S1520), the processor 310 of the oven 100 proceeds to operation S1540.

In operation S1540 of FIG. 15, when it is identified that the brightness value of the cooking chamber 102 is less than the preset reference brightness value (the preset second value) (YES in operation S1540), in operation S1550, the processor 310 of the oven 100 may control the brightness level of the lamp 120 so that the brightness of the lamp 120 increases. In operation S1540 of FIG. 15, when the brightness value of the cooking chamber 102 is identified as not being less than the preset reference brightness value (NO in operation S1540), the processor 310 of the oven 100 proceeds to operation S1560.

In operation S1560 of FIG. 15, when it is identified that the brightness value of the cooking chamber 102 corresponds to the preset reference brightness value, in operation S1570, the processor 310 of the oven 100 may obtain an exposure value from the camera 110 and proceed to operation S1420.

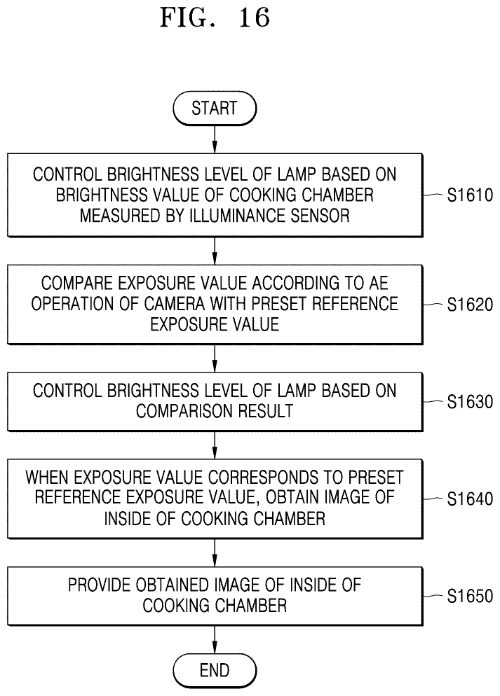

FIG. 16 is a flowchart of a method of operating the oven 100, according to an embodiment of the present disclosure.

In operation S1610 of FIG. 16, the processor 310 of the oven 100 may control a brightness level of the lamp 120 based on illuminance (a brightness value of the cooking chamber 102) measured by the illuminance sensor 130. An operation of controlling the brightness level of the lamp 120 based on the brightness value of the cooking chamber 102 measured by the illuminance sensor 130 may be performed as described above with reference to FIG. 15.

In operation S1620 of FIG. 16, the processor 310 of the oven 100 may compare an exposure value according to an AE operation of the camera 110 with a preset reference exposure value. The exposure value according to the AE operation of the camera 110 and the preset reference exposure value may be the same as described in operation S710 of FIG. 7. For example, the exposure value according to the AE operation of the camera 110 is an exposure value when the AE operation of the camera 110 is stable, and may be obtained from the camera 110. The preset reference exposure value, which is an exposure value most appropriate for recognizing an object inside the cooking chamber 102, may be obtained from the memory 320 or stored in the processor 310 to be used. The preset reference exposure value may be changed by a user.

In operation S1630 of FIG. 16, the processor 310 of the oven 100 may control the brightness level of the lamp 120 based on a result of comparing the exposure value according to the AE operation of the camera 110 with the preset reference exposure value. For example, as in operation S720 of FIG. 7 described above, when the exposure value of the camera 110 is greater than the preset reference exposure value, the processor 310 of the oven 100 may identify that brightness of the cooking chamber 102 is dark to recognize an object inside the cooking chamber 102. Accordingly, the processor 310 of the oven 100 may control the brightness level of the lamp 120 so that the brightness of the lamp 120 increases. For example, the processor 310 may control the brightness level of the lamp 120 to increase by extending an on period pulse width of a PWM signal transmitted to the lamp 120 or increasing a DC voltage value transmitted to the lamp 120. For example, when the exposure value of the camera 110 is less than the preset reference exposure value, the processor 310 of the oven 100 may identify that the brightness of the cooking chamber 102 is bright to recognize the object inside the cooking chamber 102. Accordingly, the processor 310 of the oven 100 may control the brightness level of the lamp 120 so that the brightness of the lamp 120 decreases. For example, the processor 310 may control the brightness level of the lamp 120 to decrease by reducing the on period pulse width of the PWM signal transmitted to the lamp 120 or decreasing the DC voltage value transmitted to the lamp 120.

In operation S1640 of FIG. 16, when the exposure value corresponds to the preset reference exposure value, the processor 310 of the oven 100 may identify that the brightness of the cooking chamber 102 is appropriate for recognizing the object inside the cooking chamber 102. Accordingly, the processor 310 of the oven 100 may obtain an image of the cooking chamber 102 by controlling a capturing operation of the camera 110 to be activated.

In operation S1650 of FIG. 16, the processor 310 of the oven 100 may provide the obtained image of the inside of the cooking chamber 102. For example, the oven 100 may provide the image of the inside of the cooking chamber 102 to the display 1610 included in the oven 100. Accordingly, the display 1610 may be controlled by the processor 310 to display the image of the inside of the cooking chamber 102. The user may easily and accurately check a cooking state of the cooking chamber 102 or a state inside the cooking chamber 102 based on the image of the inside of the cooking chamber 102 displayed on the display 1610 without opening the door 103 of the oven 100. For example, the oven 100 may transmit the image of the cooking chamber 102 to the user terminal 200 or the server device 300 through the communication interface 1500. Accordingly, the user may easily and accurately check the image of the inside of the cooking chamber 102 through a display of the user terminal 200. The user may control the brightness of the lamp of the cooking chamber 102 based on the image of the inside of the cooking chamber 102 through the user terminal 200.

The server device 300 may store history information (e.g., details information) related to the cooking chamber 102 of the oven 100 based on the image of the inside of the cooking chamber 102, time information when the image of the inside of the cooking chamber 102 is received, location information of the oven 100, or the like, and register the image of the inside of the cooking chamber 102 in the user terminal 200 or an SNS account of the user according to setting of the user. The server device 300 may generate and store a detailed description (e.g., food name, a cooking level of food, and amount of food) related to the image of the inside of the cooking chamber 102 based on a result of performing the AI object recognition function based on the received image of the inside of the cooking chamber 102, or provide the detailed description to the user terminal 200.

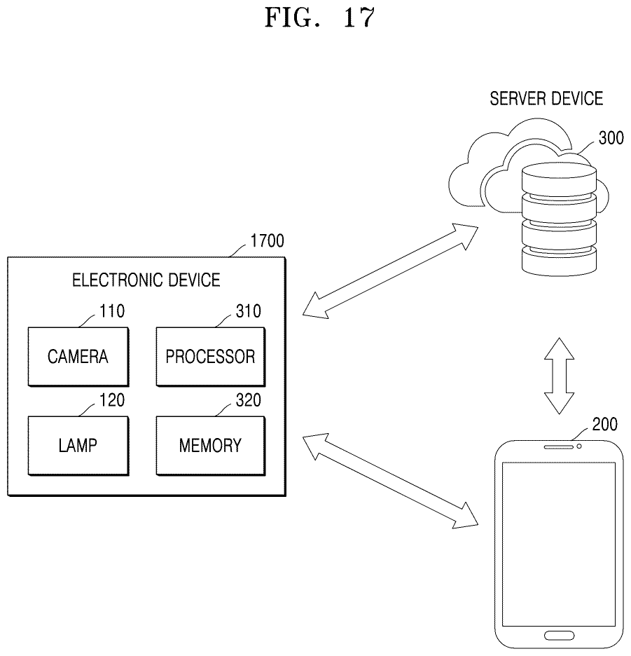

FIG. 17 is a network configuration diagram based on an electronic device 1700, according to an embodiment of the present disclosure. The electronic device 1700 shown in FIG. 17 may include a home appliance such as an oven, a refrigerator, a dishwasher, a wine refrigerator, or a washing machine. However, the present disclosure is not limited thereto.

The electronic device 1700 shown in FIG. 17 may include the camera 110, the lamp 120, the processor 310, and the memory 320 included in the oven 100 shown in FIG. 1. However, the present disclosure is not limited thereto. For example, the electronic device 1700 may further include the illumination sensor 130 shown in FIG. 12.

When the electronic device 1700 shown in FIG. 17 is a wine refrigerator, the camera 110 may be installed on a part of one of shelves mounted inside a door of the wine refrigerator. The lamp 120 may be installed at a location adjacent to the camera 110. When the electronic device 1700 is a wine refrigerator, the illuminance sensor 130 is installed at a location adjacent to the camera 110. Alternatively or additionally, the illuminance sensor 130 may have a structure in which light emitted from the lamp 120 is not directly applied. The camera 110 included in the electronic device 1700 may perform an AE operation. The processor 310 included in the electronic device 1700 may control a brightness level of the lamp 120 based on a comparison result between an exposure value according to the AE operation of the camera 110 and a preset reference exposure value. Accordingly, a clear internal image (an image of an internal space) of the electronic device 1700 may be provided. The internal image of the electronic device 1700 may be displayed through a display included in the electronic device 1700. Alternatively or additionally, the internal image may also be displayed through the user terminal 200. The memory 320 included in the electronic device 1700 may store a preset reference exposure value (e.g., first value).

In addition, the electronic device 1700 may control the brightness level of the lamp 120 by the processor 310 based on an internal lamp value of the electronic device 1700 measured by the illumination sensor 130 before the camera 110 operates. Accordingly, a time for the AE operation of the camera 110 reaches a stable state in the electronic device 1700 and a time for controlling the brightness level of the lamp 120 to obtain the clear internal image of the electronic device 1700 based on the exposure value may be reduced.

The user terminal 200 and the server device 300 may be configured to communicate with the electronic device 1700 as described in FIG. 1. The user terminal 200 may remotely control the operation of the electronic device 1700. The user terminal 200 and the server device 300 may each receive the internal image captured by the camera 110 installed in the electronic device 1700.

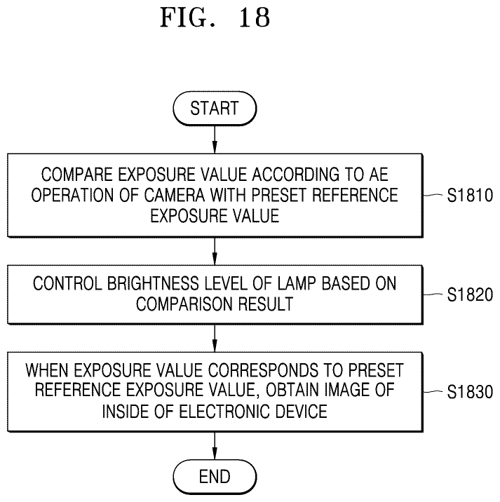

FIG. 18 is a flowchart illustrating an operation of the electronic device 1700, according to an embodiment of the present disclosure.

In operation S1810 of FIG. 18, the processor 310 of the electronic device 1700 may compare an exposure value according to an AE operation of the camera 110 with a preset reference exposure value. The exposure value according to the AE operation of the camera 110 may be an exposure value after the AE operation of the camera 110 is stable. The exposure value of the camera 110 may be obtained by the processor 310 from the camera 110. The preset reference exposure value (or a preset first value) may include appropriate exposure period information. For example, the preset reference exposure value may be determined based on object recognition of the cooking chamber 102. For example, the preset reference exposure value may be an exposure value determined as an optimal exposure value for a user to monitor the inside (internal space) of the electronic device 1700. For example, the preset reference exposure value may be an exposure value determined as the optimal exposure value for recognizing the inside (internal space) of the electronic device 1700 by using an AI object recognition function. For example, the preset reference exposure value may be set from F0 to FF. For example, the preset reference exposure value may be F2 which is one appropriate exposure value. However, the present disclosure is not limited thereto.

In operation S1820 of FIG. 18, the processor 310 of the electronic device 1700 may control a brightness level of the lamp 120 based on a comparison result. For example, the electronic device 1700 may control the brightness level of the lamp 120 so that the exposure value of the camera 110 corresponds to the preset reference exposure value. For example, when the exposure value of the camera 110 is greater than the preset reference exposure value, the processor 310 of the electronic device 1700 may identify (or determine) that brightness of the internal space of the electronic device 1700 is dark to recognize an object inside the electronic device 1700. Accordingly, the processor 310 of the electronic device 1700 may control the brightness level of the lamp 120 so that the brightness of the lamp 120 increases. For example, the processor 310 may control the brightness level of the lamp 120 to increase by extending an on period pulse width of a PWM signal transmitted to the lamp 120 or increasing a DC voltage value transmitted to the lamp 120. For example, when the exposure value of the camera 110 is less than the preset reference exposure value, the processor 310 of the electronic device 1700 may identify (or determine) that brightness of the internal space of the electronic device 1700 is bright to recognize an object in the internal space. Accordingly, the processor 310 of the electronic device 1700 may control the brightness level of the lamp 120 so that the brightness of the lamp 120 decreases. For example, the processor 310 may control the brightness level of the lamp 120 to decrease by reducing the on period pulse width of the PWM signal transmitted to the lamp 120 or decreasing the DC voltage value transmitted to the lamp 120.

In operation S1830 of FIG. 18, when the exposure value of the camera 110 corresponds to the preset reference exposure value, the processor 310 of the electronic device 1700 may identify (or determine) that the brightness of the internal space of the electronic device 1700 is appropriate for recognizing the object of the internal space. Accordingly, the processor 310 of the electronic device 1700 may obtain an image of the internal space by controlling a capturing operation of the camera 110 to be activated.

FIG. 18 may be modified to further include an operation of obtaining an exposure value according to the AE operation of the camera 110 as in operation S710 of FIG. 7 before operation S1810.

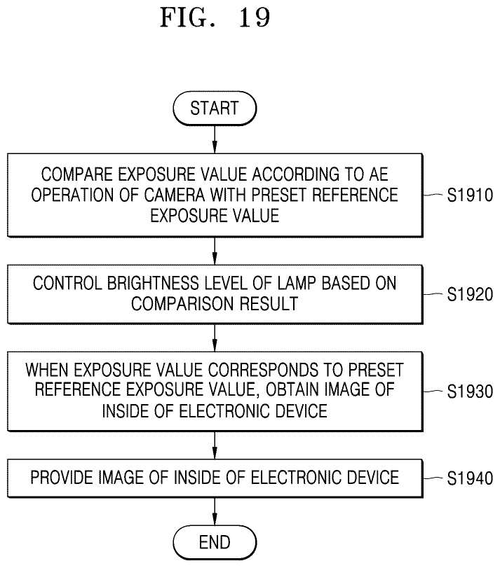

FIG. 19 is a flowchart illustrating an operation of the electronic device 1700, according to an embodiment of the present disclosure.

In operation S1910 of FIG. 19, the processor 310 of the electronic device 1700 may compare an exposure value according to an AE operation of the camera 110 with a preset reference exposure value. The exposure value according to the AE operation of the camera 110 may be an exposure value after the AE operation of the camera 110 is stable. The exposure value of the camera 110 may be obtained by the processor 310 from the camera 110. The preset reference exposure value (or a preset first value) may include appropriate exposure period information. For example, the preset reference exposure value may be determined based on object recognition of the cooking chamber 102. For example, the preset reference exposure value may be an exposure value determined as an optimal exposure value for a user to monitor the inside (internal space) of the electronic device 1700. For example, the preset reference exposure value may be an exposure value determined as the optimal exposure value for recognizing the inside (internal space) of the electronic device 1700 by using an AI object recognition function. For example, the preset reference exposure value may be set from F0 to FF. For example, the preset reference exposure value may be F2 which is one appropriate exposure value. However, the present disclosure is not limited thereto.

In operation S1920 of FIG. 19, the processor 310 of the electronic device 1700 may control a brightness level of the lamp 120 based on a comparison result. For example, the electronic device 1700 may control the brightness level of the lamp 120 so that the exposure value of the camera 110 corresponds to the preset reference exposure value. For example, when the exposure value of the camera 110 is greater than the preset reference exposure value, the processor 310 of the electronic device 1700 may identify (or determine) that brightness of the internal space of the electronic device 1700 is dark to recognize an object inside the electronic device 1700. Accordingly, the processor 310 of the electronic device 1700 may control the brightness level of the lamp 120 so that the brightness of the lamp 120 increases. For example, the processor 310 may control the brightness level of the lamp 120 to increase by extending an on period pulse width of a PWM signal transmitted to the lamp 120 or increasing a DC voltage value transmitted to the lamp 120. For example, when the exposure value of the camera 110 is less than the preset reference exposure value, the processor 310 of the electronic device 1700 may identify (or determine) that the brightness of the internal space of the electronic device 1700 is bright to recognize the object in the internal space. Accordingly, the processor 310 of the electronic device 1700 may control the brightness level of the lamp 120 so that the brightness of the lamp 120 decreases. For example, the processor 310 may control the brightness level of the lamp 120 to decrease by reducing the on period pulse width of the PWM signal transmitted to the lamp 120 or decreasing the DC voltage value transmitted to the lamp 120.

In operation S1930 of FIG. 19, when the exposure value of the camera 110 corresponds to the preset reference exposure value, the processor 310 of the electronic device 1700 may identify (or determine) that the brightness of the internal space of the electronic device 1700 is appropriate for recognizing the object in the internal space. Accordingly, the processor 310 of the electronic device 1700 may obtain an image of the internal space by controlling a capturing operation of the camera 110 to be activated.

In operation S1940 of FIG. 19, the processor 310 of the electronic device 1700 may provide the obtained image of the internal space (internal image) of the electronic device 1700. For example, the electronic device 1700 may provide the image of the internal space (internal image) to a display included in the electronic device 1700. Accordingly, the display included in the electronic device 1700 may be controlled by the processor 310 to display the internal image of the electronic device 1700. The user may easily and accurately check a state of the inside of the electronic device 1700 or a state of the object inside the electronic device 1700 based on the internal image displayed on the display included in the electronic device 1700 without opening a door of the electronic device 1700. For example, the electronic device 1700 may transmit the internal image of the electronic device 1700 to the user terminal 200 or the server device 300 through a communication interface included in the electronic device 1700. Accordingly, the user may easily and accurately check the internal image of the electronic device 1700 through a display of the user terminal 200. The user may control brightness of an internal lamp of the electronic device 1700 based on the internal image of the electronic device 1700 through the user terminal 200.

The server device 300 may store history information (e.g., details information) related to the inside of the electronic device 1700 based on the received internal image of the electronic device 1700, information about a time the internal image is received, location information of the electronic device 1700, or the like, and register the internal image of the electronic device 1700 in the user terminal 200 or an SNS account of the user according to setting of the user. The server device 300 may generate and store a detailed description (e.g., the number of wine bottles, locations of wine bottles, food names other than wine bottles, and the amount of food) related to the internal image of the electronic device 1700 based on a result of performing the AI object recognition function based on the received internal image of the electronic device 1700, or provide the detailed description to the user terminal 200.

According to an embodiment of the present disclosure, the oven 100 may include the cooking chamber 102, the oven including the camera 110 configured to obtain an image of inside of the cooking chamber 102; the at least one lamp 120 installed at a location adjacent to the camera 110; the memory 320 storing one or more instructions; and the at least one processor 310 configured to execute the one or more instructions to obtain an exposure value according to an AE operation of the camera 110 from the camera 110, compare the obtained exposure value with a preset reference exposure value, and control a brightness level of the at least one lamp 120 so that the obtained exposure value corresponds to the preset reference exposure value based on a result of comparing the obtained exposure value with the preset reference exposure value.

According to an embodiment of the present disclosure, the at least one processor 310 may control the brightness level of the at least one lamp 120 so that the brightness of the at least one lamp 120 increases when the obtained exposure value is greater than the preset reference exposure value, and control the brightness level of the at least one lamp 120 so that the brightness of the at least one lamp 120 decreases when the obtained exposure value is less than the preset reference exposure value.

According to an embodiment of the present disclosure, the at least one processor 310 may control the brightness level of the at least one lamp 120 by controlling a duty ratio of a PWM signal applied to the at least one lamp 120.

According to an embodiment of the present disclosure, the at least one processor 310 may control the brightness level of the at least one lamp 120 by controlling a voltage level applied to the at least one lamp 120.

According to an embodiment of the present disclosure, the at least one processor 310 may control the camera 110 to obtain the image of the inside of the cooking chamber 102 when the exposure value corresponds to the preset reference exposure value.

According to an embodiment of the present disclosure, the oven 100 may further include the communication interface 1500 configured to transmit and receive data to and from the external devices 200 and 300, and the at least one processor 310 may transmit the image of the inside of the cooking chamber 102 obtained by the camera 110 to the external devices 200 and 300 through the communication interface 1500.

According to an embodiment of the present disclosure, the oven 100 may further include the display 1610 configured to display the image of the inside of the cooking chamber 102, and the at least one processor 310 may control the display 1610 to display the image of the inside of the cooking chamber 102 obtained by the camera 110.

According to an embodiment of the present disclosure, the oven 100 may further include the illuminance sensor 130 installed at a location adjacent to the camera 110, and the at least one processor 310 may control the brightness level of the at least one lamp 120 based on a brightness value measured by the illuminance sensor 130, before obtaining the exposure value from the camera 110.

According to an embodiment of the present disclosure, the at least one processor 310 may compare the brightness value measured by the illuminance sensor 130 with a preset reference brightness value, and control the brightness level of the at least one lamp 120 based on a result of comparing the brightness value with the preset reference brightness value, the illuminance sensor 130 is installed in the oven 100 in a structure in which light emitted from the at least one lamp 120 is not directly applied,

According to an embodiment of the present disclosure, the at least one processor 310 may control the brightness level of the at least one lamp 120 so that the brightness of the at least one lamp 120 decreases when the brightness value measured by the illuminance sensor 130 is greater than the preset reference brightness value, control the brightness level of the at least one lamp 120 so that the brightness of the at least one lamp 120 increases when the brightness value measured by the illuminance sensor 130 is less than the preset reference brightness value, and obtain the exposure value from the camera 110 when the brightness value measured by the illuminance sensor 130 corresponds to the preset reference brightness value.

According to an embodiment of the present disclosure, the at least one processor 310 may obtain the exposure value from the camera 110 when the oven 100 performs a cooking operation, the preset reference exposure value may be determined based on object recognition of the cooking chamber 102, and the exposure value may be an exposure value detected when the AE operation of the camera 110 is in a stable state.

According to an embodiment of the present disclosure, a method of operating the oven 100 including the cooking chamber 102, the camera 110 configured to obtain an image of inside of the cooking chamber 102, the at least one lamp 120 installed at a location adjacent to the camera 110, and the at least one processor 310, includes obtaining, by the at least one processor 310, an exposure value according to an AE operation of the camera 110 from the camera 110, comparing, by the at least one processor 310, the obtained exposure value with a preset reference exposure value, and controlling, by the at least one processor 310, a brightness level of the at least one lamp 120 so that the obtained exposure value corresponds to the preset reference exposure value based on a result of comparing the obtained exposure value with the preset reference exposure value.

According to an embodiment of the present disclosure, the controlling of the brightness level of the at least one lamp 120 may include controlling, by the at least one processor 310, the brightness level of the at least one lamp 120 so that the brightness of the at least one lamp 120 increases when the obtained exposure value is greater than the preset reference exposure value, and controlling, by the at least one processor 310, the brightness level of the at least one lamp 120 so that the brightness of the at least one lamp 120 decreases when the obtained exposure value is less than the preset reference exposure value.

According to an embodiment of the present disclosure, the controlling of the brightness level of the at least one lamp 120 may include controlling, by the at least one processor 310, the brightness level of the at least one lamp 120, by controlling a duty ratio of a PWM signal applied to the at least one lamp 120.

According to an embodiment of the present disclosure, the controlling of the brightness level of the at least one lamp 120 may include controlling, by the at least one processor 310, the brightness level of the at least one lamp 120, by controlling a voltage level applied to the at least one lamp 120.

According to an embodiment of the present disclosure, the method may include transmitting, by the at least one processor 310, the image of the inside of the cooking chamber 102 obtained by the camera 110 to the external devices 200 and 300 through the communication interface 1500 configured to transmit and receive data to and from the external devices 200 and 300.

According to an embodiment of the present disclosure, the method may include controlling, by the at least one processor 310, the display 1610 included in the oven 100 to display the image of the inside of the cooking chamber 102 obtained by the camera 110.

According to an embodiment of the present disclosure, the method may include controlling, by the at least one processor 310, the brightness level of the at least one lamp 120 based on the brightness value measured by the illuminance sensor 130 mounted at a location adjacent to the camera 110 before obtaining the exposure value from the camera 110.

According to an embodiment of the present disclosure, the obtaining of the exposure value, after controlling the brightness level of the at least one lamp 120, may include comparing, by the at least one processor 310, a brightness value measured by the illuminance sensor 130 with a preset reference brightness value; and controlling the brightness level of the at least one lamp 120 based on a result of comparing the brightness value with the preset reference brightness value, and the illuminance sensor 130 may have a structure in which light emitted from the at least one lamp 120 is not directly applied.

According to an embodiment of the present disclosure, the controlling of the brightness level of the at least one lamp 120 based on the result of comparing the brightness value with the preset reference brightness value may include controlling the brightness level of the at least one lamp 120 so that the brightness of the at least one lamp 120 decreases when the brightness value measured by the illuminance sensor 130 is greater than the preset reference brightness value, control the brightness level of the at least one lamp 120 so that the brightness of the at least one lamp 120 increases when the brightness value measured by the illuminance sensor 130 is less than the preset reference brightness value, and obtain the exposure value from the camera 110 when the brightness value measured by the illuminance sensor 130 corresponds to the preset reference brightness value.

According to an embodiment of the present disclosure, the at least one processor 310 may obtain the exposure value from the camera 110 when the oven 100 performs a cooking operation, and the preset reference exposure value may be determined based on object recognition of the cooking chamber 102.

According to an embodiment of the present disclosure, the electronic device 1700 may include the camera 110 configured to obtain an image of the inside of the electronic device 1700, the at least one lamp 120 installed at a location adjacent to the camera 110, the memory 320 storing one or more instructions, and the at least one processor 310 configured to execute the one or more instructions to compare an exposure value according to an AE operation of the camera 110 with a preset reference exposure value, and control a brightness level of the at least one lamp 120 so that the exposure value corresponds to the preset reference exposure value based on a result of comparing the exposure value with the preset reference exposure value.

According to an embodiment of the present disclosure, a method of operating the electronic device 1700 including the camera 110, the at least one lamp 120 installed at a location adjacent to the camera 110, and the at least one processor 310 may include comparing, by the at least one processor 310, an exposure value according to an AE operation of the camera 110 with a preset reference exposure value; and controlling, by the at least one processor 310, a brightness level of the at least one lamp 120 so that the exposure value corresponds to the preset reference exposure value based on a result of comparing the exposure value with the preset reference exposure value.

Machine-readable storage media may be provided as non-transitory storage media. Here, the term “non-transitory storage media” only denotes that the media are tangible devices and do not include signals (e.g., electromagnetic waves), and does not distinguish the storage media semi-permanently storing data and the storage media temporarily storing data. For example, the “non-transitory storage media” may include a buffer temporarily storing data.

According to an embodiment, the method, according to various embodiments disclosed in the present specification, may be provided as an inclusion of a computer program product. The computer program product may be, as a product, transacted between a seller and a purchaser. The computer program product may be distributed in the form of a machine-readable storage medium (e.g., a compact disc (CD)-ROM) or may be distributed online (e.g., downloaded or uploaded) through an application store or directly between two user devices (e.g., smartphones). In the case of online distribution, at least part of a computer program product (e.g., a downloadable application) may be at least temporarily stored in a machine-readable storage medium, such as a server of a manufacturer, a server of an application store, or a memory of a relay server, or may be temporarily generated.

What is claimed is:

1. An oven, comprising:
a cooking chamber;
a camera configured to obtain an image of an inside of the cooking chamber;
at least one lamp disposed adjacent to the camera;
one or more processors comprising processing circuitry; and
a memory storing one or more instructions,
wherein the one or more instructions, when executed by the one or more processors individually or collectively, cause the oven to:
obtain, from the camera, an exposure value according to an automatic exposure (AE) operation of the camera,
compare the obtained exposure value with a preset reference exposure value, and
adjust a brightness level of the at least one lamp so that the obtained exposure value corresponds to the preset reference exposure value, based on a result of comparing the obtained exposure value with the preset reference exposure value.

2. The oven of claim 1, wherein the one or more instructions, when executed by the one or more processors individually or collectively, further cause the oven to:
increase the brightness level of the at least one lamp based on the obtained exposure value being greater than the preset reference exposure value, and
decrease the brightness level of the at least one lamp based on the obtained exposure value being less than the preset reference exposure value.

3. The oven of claim 1, wherein the one or more instructions, when executed by the one or more processors individually or collectively, further cause the oven to:
adjust the brightness level of the at least one lamp by controlling a duty ratio of a pulse width modulation (PWM) signal applied to the at least one lamp.

4. The oven of claim 1, wherein the one or more instructions, when executed by the one or more processors individually or collectively, further cause the oven to:
adjust the brightness level of the at least one lamp by controlling a voltage level applied to the at least one lamp.

5. The oven of claim 1, wherein the one or more instructions, when executed by the one or more processors individually or collectively, further cause the oven to:
control the camera to obtain the image of the inside of the cooking chamber based on the exposure value corresponding to the preset reference exposure value.

6. The oven of claim 1, wherein the oven further comprises a communication interface configured to:
transmit first data to external devices; and
receive second data from the external devices, and
wherein the one or more instructions, when executed by the one or more processors individually or collectively, further cause the oven to:
transmit, through the communication interface, the image of the inside of the cooking chamber obtained by the camera to the external devices.

7. The oven of claim 1, wherein the oven further comprises a display configured to display the image of the inside of the cooking chamber, and
wherein the one or more instructions, when executed by the one or more processors individually or collectively, further cause the oven to:
control the display to display the image of the inside of the cooking chamber obtained by the camera.

8. The oven of claim 1, wherein the oven further comprises an illuminance sensor disposed adjacent to the camera, and
wherein the one or more instructions, when executed by the one or more processors individually or collectively, further cause the oven to:
adjust the brightness level of the at least one lamp based on a brightness value measured by the illuminance sensor, before obtaining the exposure value from the camera.

9. The oven of claim 8, wherein the one or more instructions, when executed by the one or more processors individually or collectively, further cause the oven to:
compare the brightness value measured by the illuminance sensor with a preset reference brightness value; and
adjust the brightness level of the at least one lamp based on a result of comparing the brightness value with the preset reference brightness value.

10. The oven of claim 8, wherein the illuminance sensor is installed in the oven in a structure in which light emitted from the at least one lamp is not directly applied, and
wherein the one or more instructions, when executed by the one or more processors individually or collectively, further cause the oven to:
decrease the brightness level of the at least one lamp based on the brightness value measured by the illuminance sensor being greater than a preset reference brightness value;
increase the brightness level of the at least one lamp based on the brightness value measured by the illuminance sensor being less than the preset reference brightness value; and
obtain the exposure value from the camera based on the brightness value measured by the illuminance sensor corresponding to the preset reference brightness value.

11. The oven of claim 1, wherein the one or more instructions, when executed by the one or more processors individually or collectively, further cause the oven to:
obtain the exposure value from the camera based on the oven performing a cooking operation;
determine the preset reference exposure value based on object recognition of the cooking chamber; and
detect the exposure value based on the AE operation of the camera being in a stable state.

12. A method of operating an oven, the method comprising:
obtaining, from a camera of the oven, an exposure value according to an automatic exposure (AE) operation of the camera;
comparing the obtained exposure value with a preset reference exposure value; and
adjusting a brightness level of at least one lamp of the oven so that the obtained exposure value corresponds to the preset reference exposure value based on the comparing of the obtained exposure value with the preset reference exposure value.

13. The method of claim 12, wherein the adjusting of the brightness level of the at least one lamp comprises:
increasing the brightness level of the at least one lamp based on the obtained exposure value being greater than the preset reference exposure value; and
decreasing the brightness level of the at least one lamp based on the obtained exposure value being less than the preset reference exposure value.

14. The method of claim 12, wherein the adjusting of the brightness level of the at least one lamp comprises:
adjusting the brightness level of the at least one lamp by controlling a duty ratio of a pulse width modulation (PWM) signal applied to the at least one lamp.

15. The method of claim 12, wherein the adjusting of the brightness level of the at least one lamp comprises:
adjusting the brightness level of the at least one lamp by controlling a voltage level applied to the at least one lamp.

16. The method of claim 12, further comprising:
obtaining, from the camera, an image of an inside of a cooking chamber; and
transmitting, to external devices through a communication interface, the image of the inside of the cooking chamber obtained by the camera.

17. The method of claim 16, further comprising:
controlling a display included in the oven to display the image of the inside of the cooking chamber obtained by the camera.

18. The method of claim 12, further comprising:
adjusting the brightness level of the at least one lamp based on a brightness value measured by an illuminance sensor disposed adjacent to the camera, before obtaining the exposure value from the camera;
comparing the brightness value measured by the illuminance sensor with a preset reference brightness value; and
adjusting the brightness level of the at least one lamp based on a result of comparing the brightness value with the preset reference brightness value.

19. The method of claim 18, further comprising:
decreasing the brightness level of the at least one lamp based on the brightness value measured by the illuminance sensor being greater than the preset reference brightness value;
increasing the brightness level of the at least one lamp based on the brightness value measured by the illuminance sensor being less than the preset reference brightness value; and
obtaining the exposure value from the camera based on the brightness value measured by the illuminance sensor corresponding to the preset reference brightness value.

20. The method of claim 12, further comprising:
obtaining the exposure value from the camera based on the oven performing a cooking operation;
determining the preset reference exposure value based on object recognition of a cooking chamber; and
detecting the exposure value based on the AE operation of the camera being in a stable state.
